(19) United States
(12) Patent Application Publication
(10) Pub. No.: US 2012/0124052 A1
(43) Pub. Date: May 17, 2012

(54) Contextual Assignment of an External Descriptive and Informative Quality to a Person and/or an Object Located within a Temporal Framework

(75) Inventors: John Terence Furey, Ketchum, ID (US); Shawn Francis Phillips, Ketchum, ID (US); Vincent James Fortunato, III, Boise, ID (US); Irwin Francis Sentilles, IV, Boise, ID (US)

(73) Assignee: The ClogWorks, Inc., San Anselmo, CA (US)

(21) Appl. No.: 13/103,056

(22) Filed: May 7, 2011

Related U.S. Application Data
(63) Continuation-in-part of application No. PCT/US09/65790, filed on Nov. 24, 2009.
(60) Provisional application No. 61/117,529, filed on Nov. 24, 2008.

(51) Int. Cl. G06F 17/30

(52) U.S. Cl. 707/740; 707/741; 707/E17.083

(57) ABSTRACT

A phenomenological framework of the human perception of time identifies the Future, Past, and Present perspectives of mind. The framework is visualized as a triangle, with Future, Past, and Present mental constructs serving as an anchor at each of the three corners. The triangular plane between them represents a continuum of relative intensity for each of the constructs. Each blend of intensity in the three constructs itself corresponds to a unique set of the fundamental values and behavioral characteristics that are driven by the mental characteristics. Within this temporal framework, there is a contextual assignment of an external descriptive and informative quality to any person, group, or object—based on relative and/or absolute intensities of each mental construct—that can be used with a high level of confidence in any number of ways to interact better with the object.

### CROSS REFERENCE TO RELATED APPLICATIONS

This application is a continuation-in-part of PCT Patent Application No. PCT/US2009/065790, filed Nov. 24, 2009; which claims priority to U.S. Provisional Patent Application Ser. No. 61/117,529, filed Nov. 24, 2008; both of which are incorporated herein in their entirety by this reference thereto.

### BACKGROUND OF THE INVENTION

1. Technical Field

The invention relates to a temporal framework. More particularly, the invention relates to contextual assignment of an external descriptive and informative quality to a person and/or an object located within a temporal framework.

2. Description of the Prior Art

Traditionally, in their efforts to understand what makes people tick, psychologists and marketers have observed people and used lexical analysis of adjectives to identify and isolate independent personality traits rather than theory. The thousands of psychometrics that have grown out of this school of psychology, such as those of Myers Briggs, Birkman, DISC, VALS II, and Neilsen, each use only a tiny fraction of the many hundreds of known and validated traits with which to describe and understand a person.

It would be advantageous to provide a technique for gaining a better understanding of human traits and for applying this understanding to provide practical solutions to problems involving the many different aspects of human personalities.

### SUMMARY OF THE INVENTION

The invention is based upon a phenomenological approach to psychology that examines people through the perceptual framework that gives rise to human thinking. Thinking precedes all actions, drives all actions, and shapes personalities and realities. By accurately locating people within the phenomenological framework of thinking, the invention provides a technique that consistently predicts people's patterns of behavior in all circumstances, and correlates all manner of things both physical and conceptual that people use, interact with, or perceive, to each other, to individual people and groups of people, and to fundamental human motivations, needs, values, contributions, beliefs, and behaviors.

An embodiment of the invention provides a system for understanding all things temporal, e.g. that are of the human mind, including individual and group behaviors, job description and performance, mental skills, demographic groups, facts, ideas, consumer behavior, individual sentiments, preferences and opinions, group interaction and more, and their relationships with each other, based on their coordinates within an abstract three-dimensional framework of human temporal awareness. The system is based on a phenomenological framework of the human perception of time, that identifies the Future, Past, and Present states of mind as relating at their most fundamental level to the concepts of possibility, certainty, and control, respectively. As such, it is not related to known or expected points in linear time, i.e. Jul. 4, 1776, or today right at this nanosecond, or Jan. 1, 2013, but rather identifies the elemental human concepts that comprise mental space and that form the building blocks for all patterns of human thought: possibility {future}, certainty {past}, and control {present}.

In one embodiment, the framework is visualized as a triangle, with one of the three pure mental constructs—Future, Past, and Present—serving as an anchor at each of the three corners. The triangular plane between them represents a continuum of relative intensity for each of the constructs, in which each point on the plane represents a unique relative blend of Future, Past, and Present thinking qualities, such that those nearer the corners are far more strongly constituted of the construct they are closest to and most resistant of the constructs from which they are furthest away. In turn, each blend of relative intensity in the three constructs itself is scientifically validated to correspond to a unique set of the fundamental values and behavioral characteristics that are driven by the mental characteristics.

The invention accurately assigns individual people with a location within the temporal framework, and then associates all observable qualities about them to their location, including but not limited to their job, their preferences and tastes, their skills, their opinions and beliefs, their behaviors, the products they own or buy, the words they use and how they use them, etc.

Once assigned, the invention correlates all of these things together within this same temporal framework providing a novel and unique method for comparing, contrasting, and interacting with them.

The temporal framework provides scientifically validated external descriptive and informative qualities for each possible location, enabling a high degree of confidence in all interactions with anything located within it, including, but not limited to, more relevant search, more accurate preference ratings, better understanding of people, and more.

### BRIEF DESCRIPTION OF THE DRAWINGS

FIG. 1 is a schematic diagram that shows how the innate ability of humans to mentally time travel enables the three foundational states that comprise our awareness to exist;

FIG. 2 is a schematic diagram that shows a matrix defining a framework of the three interdependent constructs of Future thinking, Past thinking, and Present thinking;

FIG. 3 is a schematic diagram that show how the framework of the three interdependent constructs of Future, Past and Present thinking are arranged into a visualization in the form of a two dimensional, triangular plane;

FIG. 4 is a schematic diagram showing how locations in the visualized triangular map are related to the relative intensities of Future, Past and Present thinking;

FIG. 5 is a schematic diagram that shows how comparisons can be made between intensities of influence of Future, Past and Present thinking to determine differences in behavioral and temporal manifestations at different points within the framework;

FIG. 6 is a schematic diagram showing how the framework can be segmented into categories based on different blends of intensity in Future, Past and Present thinking;

FIG. 7 is a schematic diagram showing how more specific locations within the framework and within archetypical regions can be used to make more generalized projections of how individuals will behave in various scenarios;

FIG. 8 is a schematic diagram that shows how the invention locates people in this temporal framework with scientific accuracy;

FIG. 9 is a schematic diagram showing how absolute or relative intensities can be measured accurately based on a user's self-assessment;

FIG. 10 is a schematic diagram showing how two or more individual locations in the framework can be represented together to show the range of temporality of a group;

FIG. 11 is a schematic diagram showing how two or more individual locations in the framework can be represented by a single aggregate coordinate;

FIG. 12 is a schematic diagram showing how all information about a person's life can be attached to their location in the framework;

FIG. 13 is a schematic diagram showing how additional data about individuals, or their behaviors, thoughts, opinions, perceptions, etc. can be better understood through its relationship to the temporal framework;

FIG. 14 is a schematic diagram showing how additional data about people can be aggregated within the framework;

FIG. 15 is a schematic diagram showing how additional data can be associated together by proximal location within the framework, and also associated with descriptions or projections based upon relative or absolute intensities of Future, Past and Present thinking;

FIG. 16 is a schematic diagram showing all manner of things correlated by the framework;

FIG. 17 is a graphic representation of a gradient map according to the invention, allowing for color and density variations to depict data including but not limited to population of the square, intensity of preference ratings or other aggregation of data;

FIG. 18 is a graphic representation of a gradient map according to the invention, showing how ranges of responses can be used to select who is displayed;

FIG. 19 is a schematic diagram showing the total range of temporality of a group {by dashed line border}, the distribution of a subgroup {by dark region}, the aggregate location of the subgroup, with its average response to a stimulus item {the number 66, at its location}, and the location of a subgroup who responds at a preference level of 33 to the same stimulus item;

FIG. 20 is a schematic diagram showing a population of respondents {bottom map labeled ‘brown’}, the population of only those responding with mild agreement to a preference survey {the middle map labeled ‘orange’}, and the total population with color of quadrant representing the average response {top map labeled ‘color gradient,’ with quadrants represented as ‘red’ representing high agreement and quadrants represented as ‘blue’ representing low agreement};

FIG. 21 is a schematic diagram that shows how measuring people's thinking is the key to predicting their sentiments or responses to products, services, and messages according to the invention;

FIG. 22 is a schematic diagram showing the predictive values for response to a stimulus item for all locations in the framework, based on the responses to that stimulus item of people who have been located in the framework;

FIG. 23 is a schematic diagram showing how any information online, including but not limited to blog posting or Twitter posts, can be found in a more meaningful manner by its association within the framework;

FIG. 24 is a schematic diagram that shows the tying of thinking perspective to performance metrics according to the invention;

FIG. 25 is a schematic diagram that shows the identification of optimal team dynamics to maximize performance according to the invention;

FIG. 26 is a schematic diagram that shows organizational culture and team dynamics when mapped according to the invention;

FIG. 27 is a schematic diagram that shows monitoring organization-wide thinking and performance according to the invention; and

FIG. 28 is a block schematic diagram of a machine in the exemplary form of a computer system within which a set of instructions may be programmed to cause the machine to execute the logic steps of the invention.

### DETAILED DESCRIPTION OF THE INVENTION

The following discussion describes an embodiment of the invention, which provides a model of individual differences that has as its foundation the ability to mentally time travel as described in the Theory of MindTime®. Specifically, the inventors herein teach that there exists three distinct yet interdependent perspectives of thinking, each corresponding to the three temporal frames associated with mental time travel: past, present, and future. These are referred to as Past thinking, Present thinking, and Future thinking, respectively.

Moreover, the inventors teach that:

(a) measurable individual differences exist in the extent to which these three types of thinking patterns are used and, in turn,
(b) the extent to which the three thinking perspectives are used, in their individual intensities and in combination with each other, influences how individuals perceive and interact with others and the world around them.

The features of the invention include the following:
1. That the invention creates an abstract framework, comprising the three interdependent constructs of human temporality—Future thinking, Past thinking, and Present thinking, as defined by the Theory of MindTime®, that represents the total possible range of the influence of temporality on people's thoughts and behaviors.
2. That the framework can be represented as a matrix of possible profiles of relative or absolute intensities in each construct.
3. That the framework can be visualized on a map in the shape of a triangular plane where the influence of each construct is strongest on one corner, and locations between the corners represent the relative influences of each interdependent construct.
4. That ranges of intensities within a matrix or contiguous regions on the map can be defined in ways that include but are not limited to grouping around linguistic descriptions of the influences themselves {a lot of Future, more Future than Present}, or by a specific mathematical algorithm, or by predicted difference in behavior as relative or absolute intensities cross critical thresholds {such as where Future becomes a stronger influence than Past, or where all three constructs individually fall above 75% of their maximum intensity}, for the purpose of creating categories within the framework to which can be applied archetypical descriptions.
5. That the intensities of the interdependent constructs within the framework, relative and/or absolute, can be used to generate projected descriptions of manifestations of the full range of human thought and behavior that is influenced by our temporal minds, and which can be applied across all situations involving human beings. Descriptions can be either at individual intensity profiles or archetypical for ranges or regions in the matrix or map, and the more specific the location in the framework that is being described the more precise the description can be. Descriptions can include but are not limited to: world view, learning style, leadership style, communication style, relationship style, motivations, needs, contributions, values, resistances and more; and they can be made relevant to people, groups, ideas or concepts, objects or preferences or qualities or people's lives, behaviors, thoughts, perceptions, etc. in any scenario.
6. That the invention provides for measuring an individual and giving them a profile of their three-dimensional intensity score through instruments that relate and/or correlate to the three scientifically defined constructs of Future, Past, and Present thinking by the Theory of MindTime®. Currently preferred methods, with varying degrees of accuracy, include but are not limited to: a scientific inventory with statistically significant correlation to the three constructs which the inventors currently apply via an 18 or 9 item survey; or by observing individual behaviors, attention patterns, words used, and reactions to situations of individuals and relating them to behaviors projected at a specific location or range of locations or categories within the framework; or by reverse engineering, whereby observed behaviors of accurately located individuals are recorded and correlated with the influence each thinking construct exerts on them, and then using those new correlations with observed behavior as a metric for locating new individuals who exhibit these newly correlated behaviors. Measurements that are numeric can be as a raw score for intensity in each construct, absolute intensity in each expressed as a percentage out of a total 100%, or relative intensity between the three constructs whereby their total percentages add up to 100% influence overall.
7. That profiles of intensity measurements can be assigned to a coordinate set in both the matrix and to the map, including coordinates from both absolute (xx/100Future|xx/100 Past|xx/100 Present; or as a verbal example, ‘very strong in Future, moderately strong in Past, resistant to Present’) or relative (xx % Future+xx % Past+xx % Present=100%; or as a verbal example, ‘more Future than Past, a little less Present than Past’).
8. That one or more sets of coordinates can be visualized by graphical means {charts, graphs}, including but not limited to visualization at their relative location on the map. Map visualizations include but are not limited to locating specific points, and aggregating points together that are contained by contiguous regions for the purposes of consolidating information. Also, that multiple coordinates can be displayed for the purpose of visualizing the range of intensities they represent, and/or the range of descriptive categories into which they fall.
9. That a single profile measurement can be generated to represent the aggregate measurements of a group of people, and that it can represent ‘my friends’ or ‘people in this job’ etc, such that it can be visualized or mapped separately or with any other coordinates as described above, for example to look at the average location/coordinates of your group of friends as compared to the average location/coordinates of the people you work with. And that projected descriptions can be applied to group aggregate location and ranges or distributions of individual locations within the group based on the Theory of MindTime®.
10. That anything that is attributable to people, including but not limited to their behaviors, thoughts, perceptions, physiological traits, job titles, workplace performance, skills, facts about their life, demographics, preferences, etc. can be associated with the intensity profile and the resulting coordinates within the framework of the person to whom the trait is attributed. This trait can maintain its association to the person, and also be associated directly with the temporal coordinates themselves, such that a profile is created for the trait itself, i.e. preferring product X is a behavior that is observed to be associated with several temporal profiles within the framework). This trait is also collectable and usable like the group of people in 9 above (to represent the aggregate location of a thing like ‘preferring product X’ and locate it with any combination of other things). Projections can also be made about any attributed thing given group aggregate location and ranges or distributions of individual locations within the group, based on the Theory of MindTime®.
11. That comparisons can be made interchangeably between individuals, and groups and things either through their aggregate location or the ranges of locations that comprise them, based on intensity profiles or coordinates within the framework, that relate to which located person, group, preference, etc. are influenced more or less than another in any of the constructs and/or what the level of intensity of the influence is, and/or projecting how that influence is manifest in thought or behavior of people involved.
12. That descriptions based on either absolute or relative intensities or coordinates can be applied to any person, group, thing, that has the same or similar coordinates within the framework, or association with a similar range or category of locations within the framework, independently of the presence or absence of any other piece of information about that person, group, thing. Descriptions can be applied based on precise profiles or coordinates or by association with ranges or regions within the framework and the archetypical descriptions related to them.
13. That any person, group, or thing that shares an exact profile or coordinate within the framework, or occupies a similar category, range or region within the framework, can be said to be fundamentally related by virtue of the temporal qualities that are influencing them, and in the case of things, objects, preferences, etc. regardless of whether it was the same person or group of people who associated them with the framework. This includes, but is not limited to, correlations and associations between Web sites preferred, where people live, where people would prefer to live or vacation, what books they own, what kinds of books they prefer, what jobs people do, what jobs people excel at, how they communicate, etc., such that the temporal association and correlation is proven to exist in all cases, but the relevance of a particular piece of located data is higher the more real-life demographics are used as filters, i.e. the fact that surfboards resonate highly with a particular profile of thinking intensities or coordinates within the framework may be more relevant when interacting with people in southern California on the coast than with landlocked people in Colorado.
14. That by taking the intensity profile or coordinates of individuals located within the framework in combination with their individual responses to a survey, including but not limited to a preference survey for objects, pieces of media, Web sites, etc, that standard statistical regression formulas or other statistical methods can be applied to generate predictions of the responses of other people purely by association of their own location in, the framework. Such predictions can be improved by factoring in other relevant or situational demographic data into the prediction formula. Such predictions can also be used in the process of reverse-engineering intensity measurements or coordinates in the framework based on responses to correlated stimuli.
15. That observed traits and other data associated with locations in the framework, including but not limited to job titles, performance ratings, purchase patterns, etc. can be used to refine the descriptions. Also, that they may be used to better understand how to create meaningful ranges of coordinates, based on at what points behaviors can be most significantly observed to group together, for use as containers for descriptions based on the Theory of MindTime® and collections of people, groups, things, etc. that the framework projects will be relevant to one another.
16. That locations within the framework, both absolute and relative, can be used to project the interactions of any two or more people and/or groups and/or objects, that have been located by either exact location or range or aggregate location. These projections include but are not limited to: how two or more people will work together; the influence of a particular teacher on a particular student; how a particular person will respond in a particular work environment; how a group of people will react to a particular policy; whether a group of people will adopt a product or service; etc.
17. That the framework provides a method for how to move information through a thinking cycle so as to optimize the value and outcome of the information, and that the specific locations of individuals, groups, and things and/or their ranges of distributions within the framework can be used to improve collaborative efforts, direct the proper communication to people at the right time, predict strengths and pitfalls of individuals and teams, and assign roles or build teams based upon task specific skills and general thinking skills needed to fulfill expectations.

### A Presently Preferred Embodiment

An embodiment of the invention provides a system for understanding all things temporal, e.g. that are of the human mind, including individual and group behaviors, job description and performance, mental skills, demographic groups, facts relating to people, ideas, consumer behavior, group interaction and more, and their relationships with each other, based on their coordinates within a three-dimensional framework of human temporal awareness. The system is based on a phenomenological framework of the human perception of time, i.e. the very perception that enables thought to exist.

One feature of the invention is a framework that identifies the Future, Past, and Present states of mind, or dimensions of the framework, as relating at their most fundamental level to the concepts of possibility, certainty, and control, respectively. As such, it is not related to known or expected points in linear time, i.e. Jul. 4, 1776, or Jan. 1, 2013, or today right at this nanosecond, but rather identifies the elemental human concepts that comprise mental space and that form the building blocks for all patterns of human thought.

In one embodiment, the framework is visualized as a triangle, with one of the three pure mental constructs—Future, Past, and Present—serving as an anchor at each of the three corners. The triangular plane between them represents a continuum of relative intensity for each of the constructs, in which each point on the plane represents a unique blend of Future, Past, and Present thinking qualities, such that those nearer the corners are far more strongly constituted of the construct they are closest to and most resistant of the constructs from which they are furthest away.

This two-dimensional triangular plane is used to create a map for the purposes of visualizing anything individually or collectively that has been located within the framework, and the relationships between any two or more things that have been located within the framework.

In turn, each blend of intensity in the three constructs itself is scientifically validated to correspond to a unique set of the fundamental values and behavioral characteristics that are driven by the mental characteristics.

An embodiment further comprises a scientific model of human thinking, which adds a new range of temporal values or qualities, including resistance to change, need for order, pursuit of opportunity and others, to those currently measured by traditional lexical, trait-based psychometrics. In addition, it is also scientifically validated to include personality traits, such as those measured by VALS, NEO, or Myers Briggs where, for example, a particular location within the triangle corresponds to extroverted behavior, and another corresponds to conscientious behavior.

The system assigns a numerical value to a person's intensity in each of three constructs in the framework that, in one embodiment, is expressed as a percentage. The three percentages are taken together to represent a person's three coordinates within the framework. Thus, a person whose individual intensities each of the three dimensions of the framework were 88% Future thinking, 77% Past thinking, and 42% Present thinking would have coordinates of 88/77/42 within the framework.

A first, scientifically validated, method for defining a person's intensity, also called their score, involves their responding to a set of 18 statistically relevant statements aimed directly at measuring Future, Past, and Present thinking within people. Responses are collected on a bar with 100 gradations, and scores on statements relating to each construct are resolved to an average percentage score for each.

Within the system, people's scores represent the relative similarities and differences of the mental qualities and behaviors they exhibit, allowing for direct description of people and things based on their specific intensities in each individual dimension in the constructs in the framework, and direct comparisons between them based on their relative differences in intensity of Future, Past, and Present thinking.

Thus, all people with a Future coordinate of 88 have the same intensity of Future thinking, and share fundamental temporal qualities of that intensity of Future thinking, such that one direct correlation can be made between people and objects that share any one intensity factor. Further, there is a more refined set of temporal qualities built upon these individual intensities, such that a person with Future coordinate 88/Past 44/Present 44 correlates with a different temporal manifestation than a person with coordinates Future 88/Past 77/Present/77: while both people have strong skills and characteristics of Future thinking patterns the former is driven by those patterns more specifically due to having less of the other two kinds of thinking skills, and thus exhibits different manifested behavioral patterns.

The system then uses the numerical scores to associate individuals with categories, based on a range of intensities, for the purpose of assigning a conceptual or linguistic description to them that is based on the qualities and behaviors the framework associates with the blend of Future, Past, and Present thinking in their generalized range of coordinates. Each description captures the archetypical behavioral qualities that are associated with the range of scores in that category. The descriptions may be written, visual, auditory or communicated by other media or methods.

Depending upon the specificity of detail needed about how a person thinks, different levels of categorization have been developed. The most simple categorization comprises a set of three, determined by the construct in which the person has the highest intensity. Blends are represented at their most basic by a set of seven or ten categories, and in a complex form for describing the specific interactions between individuals, in groups they are expressed at the level of 95 categories. More categories are developed by further division, based on ranges of numerical scores, to capture more specific and nuanced groups of individuals.

The system uses individuals' scores and the categories the individuals fall within to create groups of people who share behavioral traits based on the quality and intensity of their thinking, and also to associate specific observed and recorded real-life behaviors, demographics, opinions, and beliefs to specific coordinates within the framework.

Once a person's intensity has been determined, and they have a coordinate within the framework, the system attaches all manner of existing and to-be-collected behavioral data about their life, their activities, or their thoughts to their coordinates.

Capturing information through online and intranet interaction is one way of collecting data, but in other embodiments it could also be hard-coded or hand entered into a database or filing structure. In addition to concrete demographic data and observed behaviors, such as mouse clicks, the system can also attach information from text, photos, images, music, or movies that people create, show preference for, or share with others, for example the words used in an email, or the subject matter of a photo posted online, to the coordinates of the person who posted the content.

Thus, it can be said that because a person with coordinates 88/77/42 lives in zip code 83340, drives an Audi station wagon, and posts articles from the New York Times science section to their Facebook page, the mental and behavioral characteristics associated with those coordinates exist in that town, are evidenced in the decision to buy that car, and are driving their preference for the science section of the Times, and their motivation for sharing news articles on a social network.

The system can also capture and associate preference ratings of any resolution by attaching individual responses, for example a user satisfaction rating of 55/100, to their coordinates in the same manner. In this way, the system can locate all coordinates where a response of 55/100 has been attached, or also locate and group all coordinates where a range of responses, for example from 80/100 to 100/100, have been attached.

As more data about more people's behavior is attached to more coordinates, the system effectively maps the world of all human behavioral patterns to a phenomenological framework that describes the total possible range of human mental patterns.

The presently preferred embodiment of the invention provides a system that has two ways of producing meaningful information about individual traits and behaviors, both of which rely on the creation of demographic groups of the people who exhibit a particular trait or behavior of interest.

The first way is to determine the range of coordinates to which the trait or observed behavior has been attached. For example, if the residents of zip code 84430 were located in the framework with scores 86/47/85; 74/63/86; 95/36/26; etc, the behavioral qualities of that town would include all of the behavioral qualities of its residents. By sorting the coordinates into category groups, by range of score, the system determines the percentage of individuals in each category to determine the relative numbers of individuals within each. Thus, in terms of the seven simple categories referenced above, the group may be comprised of 10% Future, 20% Future/Past blend, 10% Past, 30% Past/Present blend, 10% Present, 0% Present/Future blend, and 20% Integrated blend. This represents the percentage of mental energy within the group that is made up of the archetypical qualities of each category, and describes the kinds of thought-driven behaviors that the group exhibits, and the degree to which they are exhibited.

The second way builds upon the first by determining the average intensity for all members of the demographic group, e.g. people who live in a certain place, have bought the same product, or do the same job, in each of the three constructs to develop a single coordinate that represents the aggregate of the group of coordinates to which are attached any specific behavior or trait. This enables direct description within the framework of the temporal qualities that people associate with any trait, behavior, idea, opinion, or preference. It also enables direct comparisons between traits, behaviors, ideas, opinions, and preferences, both with each other and with individuals and other groups of people based on the relative intensities of the temporal qualities, e.g. those springing from hope and possibility, truth and certainty, and harmony and control, that are associated with them.

For example, the aggregated coordinates of the group of people who have declared biology as their major represents the dominant mental values that group associates with pursuing that biology major.

With regard to creating coordinates for preference ratings, the system can either aggregate a group of coordinates for a single preference response {55/100} or for a range of responses {0/100-20/100}. In the case of preference ratings, the system does not simply aggregate the coordinates of all respondents because that would weigh high preference or agreement equally with low preference or disagreement. Instead, the system identifies the quality of the response, for example coordinates for the group of people who rated their quality of life in zip code 83340 most highly, i.e. in the 80 to 100/100 range, and creates an aggregated coordinate to identify the mental qualities associated with a particular opinion or belief about a thing or person, rather than simply with the thing or person itself.

For example, the coordinates for a high opinion of quality of life may be significantly different from those representing a low opinion, such that living in zip 83340 may represent an even distribution of coordinates, and therefore qualities and values, but the coordinates for enjoying life there may correlate more strongly to hope, possibility, and the values that flow from them, while the coordinates for not enjoying life there may correlate more strongly with harmony, control, and the values they flow from them. In contrast, the perception of having a high quality of life in zip code 83333 may have an opposite set of associations. The same holds for enjoyment of movies, satisfaction with jobs, support for political initiatives or candidates, or anything else that is related to objective opinion. It can be applied to suggest where a person with a particular set of coordinates should live {83340 or 83333}, what kinds of media they will enjoy, what kinds of jobs will hold their attention, what policies or candidates will most resonate with their value system, and more.

The system uses a regression analysis formula to predict preference responses to any piece of stimulus, for any individual or group who has their own coordinates within the framework, based on the responses of other people before them who both have coordinates and their previous responses to the same piece of stimulus.

As behavioral data is collected and associated with a set of coordinates in the framework, that data can be used to reverse engineer a set of coordinates based on observing a similar set of behaviors in other people and correlating the degree of difference between those observed behaviors and the coordinates in the framework that are most strongly representative of them.

One example of this would include identifying such things as the pages visited in a Web site, the order of clicking to navigate to them, which ads are clicked, and/or the time spent on each {among other possible observed behaviors} for individuals with known locations in the framework. The more highly correlated the observed behaviors are to the three dimensions of thinking within the framework the more accurately an exact set of coordinates can be applied. When a similar behavioral pattern is observed in an individual who has not yet been located, the set of mental and behavioral correlations associated with the located individuals can be applied to the new individuals—even to the degree that a few mouse clicks may be enough to already associate that new individual with a categorization within the system for a purpose such as, but not limited to, exposing them to the ads preferred by those already located within that category. While the system attaches all observed behaviors to specific coordinates and calculates the differences and similarities between them, it also uses its categorization system, based on ranges of coordinates, to group behavior, preference, and opinion into meaningful sets that are capable of generating predictions and associations for previously unrelated things.

When the coordinates of two or more traits, observed behaviors, preferences, or opinions fall within the same category, the system directly relates them to one another based on the archetypical temporal qualities they share and regardless of whether the behavioral data was collected from the same group of people. This allows for broader and more sophisticated correlations between people and things than is currently possible under traditional data mining procedures.

Thus, the degree of preference that one set of respondents shows for a political policy in the area of energy is correlated to the preference a different set of respondents shows for a different policy in the area of health care.

The system further refines these correlations through the use of traditional demographics. Thus, the preferred policies of a group of people who are declared Democrats may prove to differ from the preferred policies of declared Republicans, or the preferences of Democrats who are small business owners may differ from those of Democrats who are members of labor unions. However, the fundamental motivations driving those opinions, and the means by which those preferred policies is pursued, is shown to have similar sources if the aggregated coordinates representing those preferences result in the same categorization within the framework {to the degree of specificity given how narrowly the categories are defined by the tightness of their ranges of coordinates}.

Thus, if a unique group of people who are observed to have voted for candidate A have an aggregated coordinate within the framework of 50/80/65, and another unique group of people who regularly purchase product X have an aggregated coordinate of 51/79/66, the system correlates voting for candidate A with buying product X. As with all statistics and data mining procedures, the more people within a population that are measured the greater the accuracy of the correlation, and also the more demographically alike the unique groups are to begin with, the more accurate the correlation, such that if we are looking only at unique groups made up of females aged 18-24 who are registered Democrats and live in zip code 83340, and find this correlation between candidate A and product X, the correlation is more relevant within that specific demographic than within a larger demographic such as all females living in zip code 83340, or all females aged 18-24 who live across the country.

The system enables this refinement through the selection of groups based on user description of meaningful demographics, as well as with the aid of statistical factor analysis including but not limited to statistical correlations and factor analysis that identifies which recorded responses and observed behaviors hold together.

For example, within a given sub-demographic of people {among Democrats, those that live on the west coast or those that make under $100K a year} and a given set of stimuli and/or observed facts {statements of belief about particular policies and/or information about who they voted for in the last several elections} it may be found through factor analysis that a high preference response for one policy or a vote for one candidate also correlates to a high preference with two others and that high preference response to a fourth item also correlates to high preference for a fifth, sixth, and seventh. The system combines the individuals who make up each group {those that prefer the first set and those that prefer the second} into a new unique demographic, identifies the aggregate coordinates for each group, and makes correlations with previously unrelated demographics, ideas, things, and behaviors {including but not limited to what people have searched for online or what they have bought} by looking for which of these previously unrelated demographics have similar sets of coordinates within the framework. This factor analysis serves to flag which observed behaviors may be most likely to be driven by similar motivations, and therefore which kinds of subgroups should be identified as unique demographics and located within the framework.

For any recorded behavior which, through its association with and/or correlation to a set of coordinates in the framework and/or direct or indirect correlations to the three constructs in the framework—Future, Past and Present thinking—these behaviors can then become observed in people who have not yet been located within the framework to give them locations by way of either intensities, coordinates or descriptive categories, in effect reverse engineering a location in the framework from a set of observed behaviors, and increasing the ease with which individuals (and through them all information about their lives) can be located within the framework because the locating does not need to occur through their conscious participation in any particular survey.

Furthermore, the behaviors, skills, perceptions, values, etc. projected by the descriptions of archetypical categories can be used, separately and/or in combination with observed traits and behaviors of individuals located within the framework, to generate both a general method for moving ideas and information through a thinking cycle so as to optimize the value and outcome of the information, and that the specific locations of individuals, groups, and other associated information, and/or their ranges of distributions within the framework can be used to improve collaborative efforts, direct the proper communication to people at the right time, predict strengths and pitfalls of individuals and teams, and assign roles or build teams based upon task-specific skills and general thinking skills needed to fulfill expectations.

The steps involved in the implementation of a presently preferred embodiment of the invention are as follows, given the below brief summation of the theory and framework:

A phenomenological framework of the human perception of time identifies the Future, Past, and Present states of mind as relating at their most fundamental level to the concepts of possibility, certainty, and control, respectively. The framework is visualized as a triangle, with one of the three pure mental constructs—Future, Past, and Present—serving as an anchor at each of the three corners. The triangular plane between them represents a continuum of relative intensity for each of the constructs, in which each point on the plane represents a unique blend of Future, Past, and Present thinking qualities. Each blend of intensity in the three constructs itself corresponds to a unique set of the fundamental values and behavioral characteristics that are driven by the mental characteristics.

1. Create absolute coordinates for a person in the three thinking dimensions, Future, Past and Present. Methods include but are not limited to: responding to 18-statement thinking style profile survey which we have already scientifically validated; collecting activities or other facts about people that have already been correlated within the framework—such as mouse clicks, purchase history, etc—and reverse-engineering the coordinates of a new person based on similarities in their observed behaviors and other observed facts about them.

The current 18 statements, which people respond to on a scale of strongly-agree to strongly-disagree are as follows:

### Future Thinking Statements

“I am known for invention/innovation.”
“I am always on the lookout for new opportunities.”
“People think of me as a visionary.”
“I am regarded as an agent of change.”
“People think of me as dynamic.”
“I am known for generating ideas.”

### Past Thinking Statements

“I often think about past experiences.”
“I often think about past decisions.”
“I agonize over making the right decision.”
“I tend to second guess myself.”
“I tend to dwell on “what was”.”
“I usually reflect carefully on what I know to see how it applies to the current situation.”

### Present Thinking Statements

“People think of me as structured.”
“I prefer to work in a tidy work environment.”
“People think of me as organized.”
“Being organized is important to me.”
“People think I am best at planning and organization.”
“I am driven towards order.”

In one presently preferred embodiment the results to each statement are recorded on a scale of 1 to 100, with 1 representing strong disagreement and 100 representing strong agreement. The scores for all statements within each thinking dimension are averaged, and the resulting average is taken to be the coordinate for that thinking dimension:

In this example with six items for the Future thinking dimension, the future coordinate equals:

{Future Item 1 score}+{Future Item 2 score}+ . . . {Future Item 6 score}/{Future Item 1 highest score possible}+{Future Item 2 highest score possible}+ . . . {Future Item 6 highest score possible}

Past and Present coordinates are calculated in the same manner.

As the system collects additional preference ratings on new items, it calculates the correlation between that preference rating and each, of the three fundamental dimensions in the framework {Future, Past, Present}. As preferences for new items are shown to have higher correlation than existing statements, the system replaces lower-correlating items with any that have higher correlations. There is no reason for the number of items used to be exactly 18, nor for there to be an identical number of items in each of the Future, Past and Present dimensions, such that as additional data is collected, if the highest aggregate correlation were to result from two Future statements, 19 Past statements and six Present statements, then that may become the preferred embodiment. Further, depending upon the amount of time and attention that a particular audience of respondents may demonstrate, within a particular deployment of the invention within that audience as low as one item per thinking dimension may be used to generate locating coordinates. While the scientific accuracy of using only one item may be shown to be lower than using a broader sample of items, the system still identifies valid coordinates that will be useful in applications that demand less specific or statistically accurate results.

2. Assign temporal cognitive and behavioral qualities to the person based on the absolute coordinates in each of the three dimensions, such that a person with a Future coordinate of 90 contains a high degree of Future thinking qualities regardless of their other coordinates, and a person with a Future coordinate of 45 has a very low degree of Future thinking qualities regardless of their other coordinates {to the point of resisting those Future qualities . . . the cutoff being above/below a coordinate of 50, and below 50 indicating a resistance}.
3. Associate those absolute coordinates with a relative position within the framework by creating percentages of the whole out of the absolute numbers, such that coordinates of 100/50/50 and 80/40/40 map to the same relative location within the two-dimensional, triangular framework, such that in a relative sense they have 50% of their mental energy in the Future dimension and 25% in the Past and Present dimensions respectively, or in other words twice the mental energy in the Future dimension than in the Past and Present, which in this example are of equal proportion.

This always equates to:

Future percentage={Future coordinate}/{Future coordinate}+{Past coordinate}+Present coordinate)

Past and Present percentages is calculated in the same way.

4. Assign the temporal cognitive and behavioral qualities that exist at that relative location based on the theory and framework to the individual located there. (see Pseudo-code 1 below)
5. Record additional information about the person, including but not limited to: their opinions, comments, behaviors, what they own, where they live, physical characteristics including race or gender or age, preferences, words they use, beliefs they hold, religion, education, job, or any other thing that can be connected to a person.
6. Associate things recorded about a person to each of their absolute coordinates as well as to their relative location within the framework, such that a person with coordinates 90/60/30 who responded to a survey statement with a response of 80 out of 100 positive would associate their 80 out of 100 opinion to the Future coordinate of 90 intensity, Past coordinate of 60 intensity and Present coordinate of 30 intensity, as well as associating it with the full coordinate of 90/60/30, as well as associating it with the relative blended location in the map where in this example 50% of the temporal qualities are in the future dimension, 33% are in the past dimension, and 17% are in the present dimension. (see Pseudo-code 4 below)
7. Group people who have been located within the framework together based on commonalities among these additional recorded facts, for example a group of people who work at the same company, or in the same job role, or who all respond strongly positive to the same piece of stimulus material, etc. (see Pseudo-code 5 below)
8. Create a single set of absolute coordinates for that group of people by taking the average of all group members in each coordinate, such that in a group of three people with coordinates 80/70/60; 50/90/30; 50/50/30 the singular group coordinate would be 67/70/40. (see Pseudo-code 5 below)
9. Assign those coordinates to the observed/recorded characteristics that defined the group, such that if those three people all shared the same job description, the coordinates for that job would be 67/70/40. The more representative the group of people measured is to the total possible group of people who share the characteristic, the more accurately the coordinates truly represents the temporal location of that characteristic, i.e. assuming those three people were bus drivers, if they were the only three bus drivers in the world then there would be 100% confidence in the accuracy of the coordinates 67/70/40 as the temporal location of being a bus driver. However, even in cases where the sample size may be statistically insignificant of {in this case} the profession of bus drivers as a whole, the invention is still scientifically accurate in providing detailed information about what kind of bus drivers these three people are in terms of their motivations, needs contributions, communication style, decision-making style, relationship style, world view, and resistances, among many other things, based on their location in the phenomenological framework of thinking even absent any other piece of information about them, such that those coordinates are valid and actionable given interactions with those three individuals specifically. (see Pseudo-code 4 below)
10. Once coordinates for a non-human thing {from an object to an action to an idea to an opinion to a preference} have been assigned, based on the coordinates of the people associated with that thing, steps 2-4 above are applied to that thing. People and things are now correlated to one another based on their absolute and relative locations/coordinates within the temporal framework of human cognition.
11. Make direct comparisons between people, things and each other based on both their absolute coordinates and relative positions within the framework, such that all people and things that have a Future coordinate in the 80-100 range are highly associated with Future thinking concepts, although those with a coordinate of 88 are more strongly associated with them than those with a Future coordinate of 87, and also that among all those with a Future coordinate of 88, those with Past and Present coordinates that more significantly lower are more uniquely representative of Future thinking qualities than those with Past and Present coordinates which are closer to or above the Future coordinate.
12. Group together individuals who have been located within the framework based on a singular coordinate or on ranges of coordinates, such as but not limited to those used to generate the categories used for containing actionable linguistic descriptions {as explained above}.
13. Collect the entire scope of associated things from Step 6, above, from all people who inhabit a singular coordinate or a range of coordinates. A real-life behavioral profile has now been created for that coordinate or range, such that in cases where a particular thing {observed behavior, trait, belief or opinion, or other fact} exists in more than one coordinate or range it can be accurately determined that the people in one location have a different, identifiable, and actionable relationship to that thing than people in another location. Example: people who live at zip code 83340 fall into numerous ranges of coordinates within the framework, and therefore these people live there for different reasons, have different and identifiable perceptions and thoughts about living in that place, and will act on those perceptions in different and identifiable ways.
14. Plot the coordinates for any and all people and things into a graphical format for improved understanding and interaction with the coordinates. One preferred format involves plotting the relative locations of things into a map shaped like a triangular, two-dimensional plane such that, if each coordinate represented the intensity of a spring pulling a dot from the center of the map to its corner, the actual position would be representative of the relative differences in strength of pull, where a stronger or more intense spring brings the dot closer to that corner.

People and things can be plotted individually at specific points on the plane, or to simplify the visualization of larger amounts of data, the triangular plane may be divided up into shapes including but not limited to squares, rectangles, and triangles such that each shape represents the total number of people and/or things falling into it. Shapes may be colored to represent different kinds of items {people/things/etc} and/or toned to represent the absolute or relative number of items, such that in one preferred visualization the shapes with more units of people or things are shown to be darker than those with fewer. Other visual models include but are not limited to a bar chart showing absolute intensity in each of the three dimensions, or a pie chart showing the relative intensities of each dimension. (see Pseudo-code 2 below)

15. Given all people who have been located within the framework, collect all those who have responded to a particular stimulus item to determine the statistical correlation between a particular response and the location within the framework of the respondent, and through standard statistical regression analysis procedures predict the response to that item for other people located within the framework based on their coordinates in the three dimensions within the framework.
16. Create a visualization of these predictive correlations by first creating predictions for all possible locations within the framework, or creating predictions for an evenly distributed set of coordinate {such as but not limited to 50/50/50; 55/50/50; 60/50/50; 55/55/50; 60/55/50, etc} with the tightness of the distribution dependent upon the degree of accuracy required and time available for completing the calculation. Then plot the responses on the triangular map as described in Step 14 above, such that at any location on the plane there may be an absolute coordinate with a predicted preference response of 88/100 to a particular item as well as another absolute coordinate with a predicted response of 50/100. To simplify the visualization of this data the triangular plane may be divided up into shapes as described in Step 14 above, the aggregate predicted responses for all coordinates that map to the shape are averaged, and in one preferred visualization shapes with the most positive response to a preference item are colored red and those with a more negative response are colored towards the blue end of the color spectrum in a manner that mimics a traditional map showing temperatures on the earth's surface {where red areas are hottest, orange is warm, green is less warm, and blue regions are cold}. (see Pseudo-code 6 below)

### Implementation

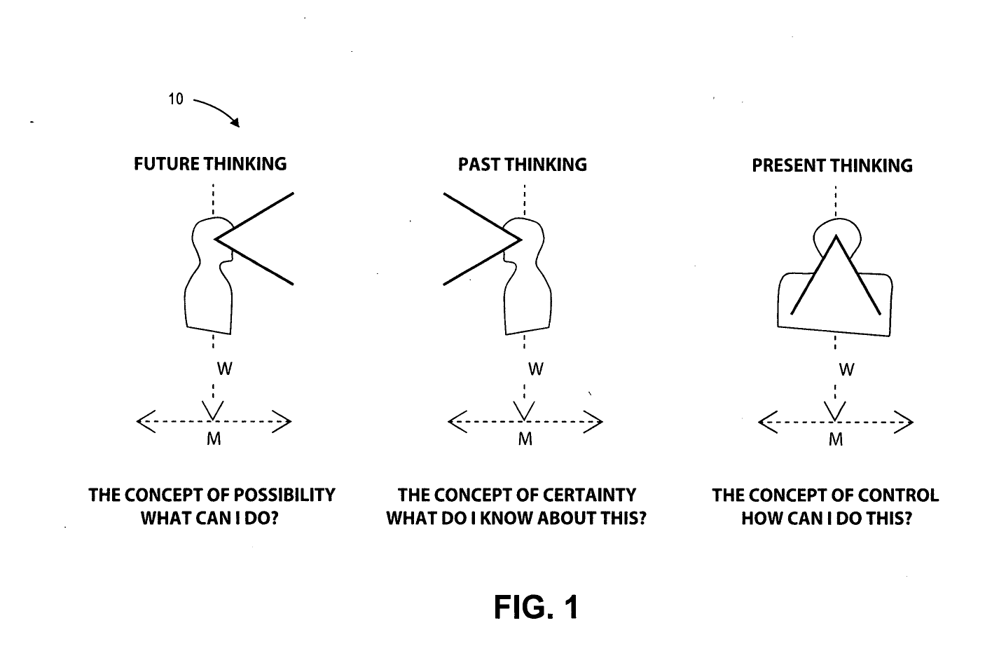

FIG. 1 is a schematic diagram 10 that shows how the innate ability of humans to mentally time travel enables the three foundational states that comprise our awareness to exist.

It is upon these states of awareness that all thoughts are built.

According to the late Julian Jaynes, author of The Origins of Consciousness, “Time creates the space in which we think and imagine.” Decades earlier, Einstein noted that “Space and time are both forms of thought.” And for millennia the Buddhists have taught that time is the product of distinction-making in the mind.

The invention herein is built upon the realization that all people experience the world through the phenomenon of time, and that time forms the framework of thought for all humans. It is our individual and usually unconscious relationship with the phenomenon of time that shapes our personalities and behaviors in a highly predictable way. When people become conscious of this relationship, at work in their lives its fundamental influence becomes self-evident to them. The herein disclosed model is a powerful, breakthrough approach to understanding people because it is quickly understood and easily adopted by experts and laypeople alike; its underlying language, i.e. time, is intuitively understood by all.

We each are influenced by a blend of Future Thinking, Past Thinking, and Present Thinking and the mental concepts that arise from them. It is this blend of thinking, i.e. our individual thinking style, that impacts what we focus on, what we pursue, what we avoid, who we relate to, what we criticize, what we value and what we believe. Even global financial markets are driven by people's thinking.

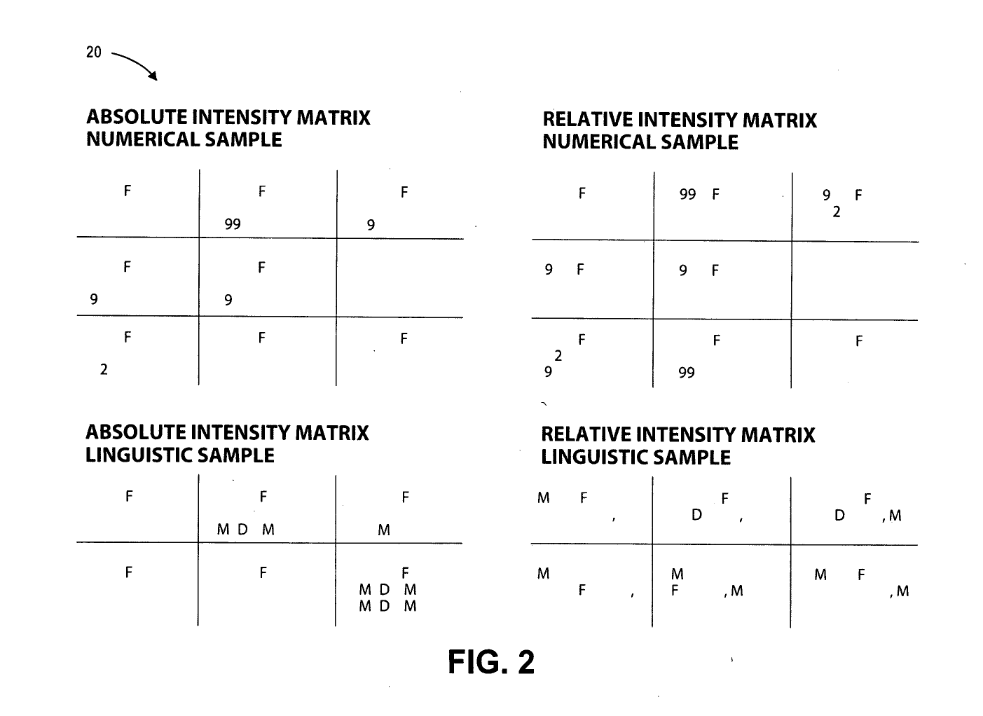

FIG. 2 is a schematic diagram 20 that shows a matrix defining a framework of the three interdependent constructs of Future thinking, Past thinking, and Present thinking.

Locations in the framework can be conceived of as being measured in absolute intensities, where each construct is measured individually in relation to the total possible influence it can exert, as a relative percentage of the total temporal influence any individual experiences, and can be expressed either as a numeral or with a linguistic or conceptual descriptive.

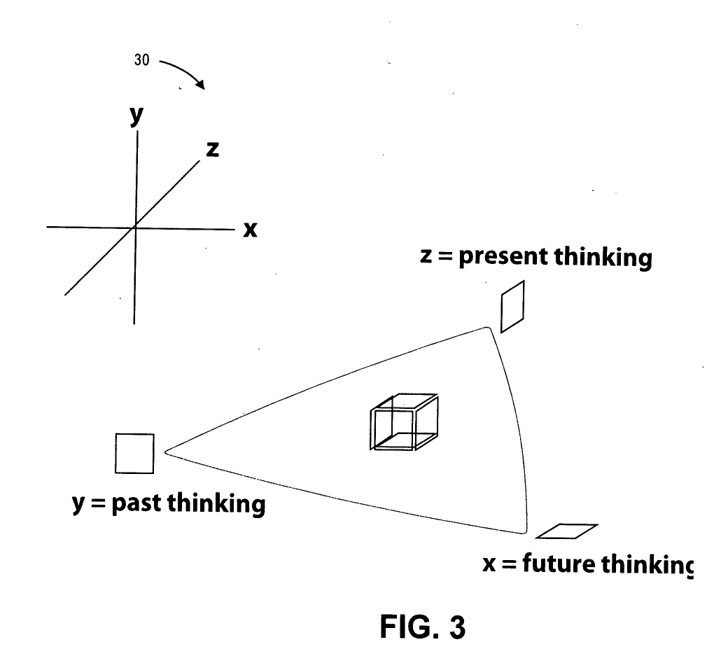

FIG. 3 is a schematic diagram 30 that show how the framework of the three interdependent constructs of Future, Past and Present thinking are arranged into a visualization in the form of a two dimensional, triangular plane.

Because the three constructs are interdependent, a triangular arrangement allows their relative intensities to be visualized. It also allows for absolute intensity blends that have similar relational values to be grouped together without creating a mathematical algorithm to group all similar blends of absolute intensity.

Wherever the triangular map or the concept or relative intensities is discussed, using absolute intensities in each construct allows for more accurate descriptions and predictions based on the Theory of MindTime.

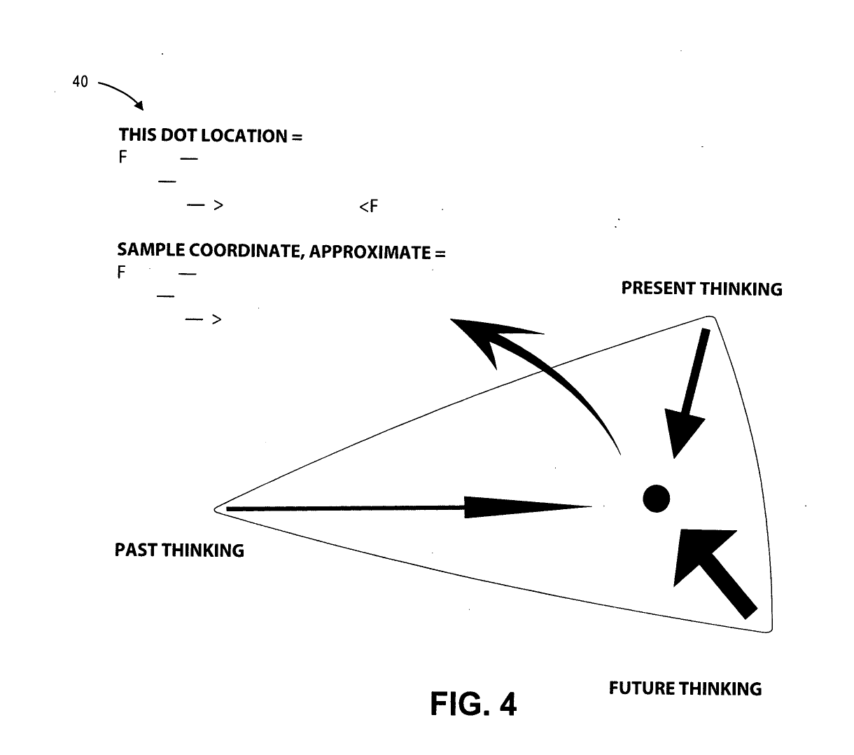

FIG. 4 is a schematic diagram 40 showing how locations in the triangular map are related to the relative intensities of Future, Past and Present thinking.

The pull of each region of the map is equivalent to each relevant section of a survey according to the GPS for the Mind module or any other locating instrument, and is equivalent to a location on the map according to the invention. In methods where absolute intensity of each construct is measured individually, the absolute intensities are converted to relative intensity for the purpose of mapping to the triangular plane.

As people rate things or attach things to their profile, including pictures, comments, links, personal data, tags, etc, those things are attached to the world of thinking at the location of the person who attached them.

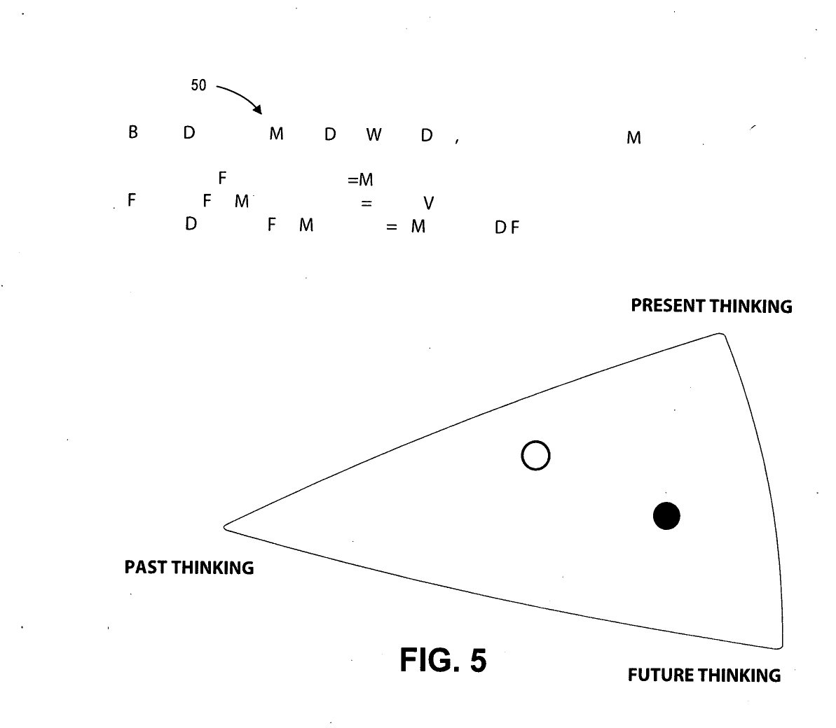

FIG. 5 is a schematic diagram 50 that shows how comparisons can be made between intensities of influence of Future, Past and Present thinking to determine differences in behavioral and temporal manifestations at different points within the framework.

By looking at how close or far away various persons or objects are from the corners of the visualized triangle, comparisons can be made between them individually, as can projections about how each reacts to or influences the other; comparisons include but are not limited to how two or more people react to each other, or any thing such as a policy, product or piece of media.

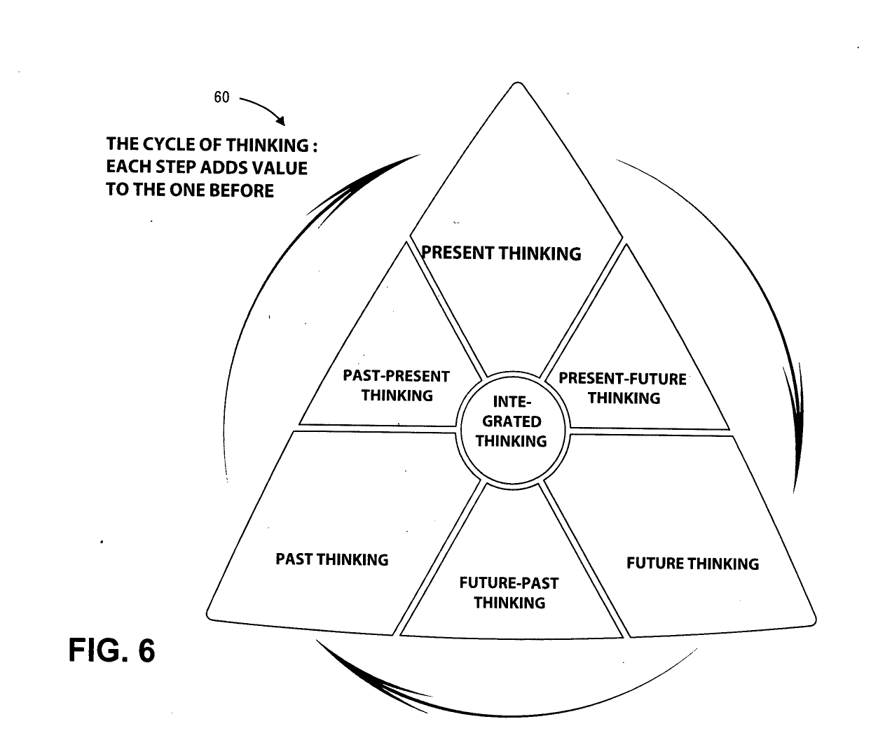

FIG. 6 is a schematic diagram 60 showing how the framework can be segmented into categories based on different blends of intensity in Future, Past and Present thinking.

Breaking up the framework, either by relative location or by ranges of absolute intensities, allows for archetypical descriptions to be made that apply to similar groups of people or objects. For the temporal and behavioral manifestation of a person, the following pieces of text describe a presently preferred method of creating seven categories for the purposes of giving a simple overview of the world of temporality.

### Thinking Style: Future Archetype: Optimistic Vision Role: Inspiration

The value of Optimistic Vision lies in its ability to envision what others cannot and to see how things can always change. To have a vision of what could be in place of that which is requires a long view and an open, unfettered mind. Optimistic Vision brings big ideas and spreads contagious enthusiasm, holding no fear of being a nonconformist and a protagonist of possibility. This includes revealing abstract ideas to others by using simple but powerful metaphors. The great strength of this archetype lies, in part, in refusing to acknowledge or be bound by what already exists and by others' rules. Its true gift is one of generating ideas and offering vision and hope.

### Thinking Style: Future-Past Archetype: Recognizing Truth Role: Curiosity

The value of Recognizing Truth lies in its ability to know when an idea sounds right. This knowledge, combining a recognition of truth in tandem with an open, inquisitive disposition, can be the first step in the process of discovery. Curiosity leads to uncovering new things, while an emphasis on evidence and verification help to identify the new possibilities that ring truest. Led by intuition, but also in need of finding validating evidence, Recognizing Truth takes visionary ideas and adds depth of thought to them. With skeptical openness and a passionate thirst for learning, it leads the way for those who would explore things more deeply. Its true gift is one of envisioning the future and evaluating its possibilities.

### Thinking Style: Past Archetype: Finding Meaning Role: Forging Deep Connections

The value of Finding Meaning lies in its ability to look deeply for answers to the question: What does it all mean? The questions asked are often big; its method, though, is to delve into the minutia using sound and accepted methods. Nothing is taken on faith, and trust is of paramount importance: trust in methods, trust in a small and close group of people, and trust in one's ability to reason. With an acute sense of the important questions to ask and where to go looking for the answers, Finding Meaning wants more than anything to celebrate what can be proven. Its true gift is one of finding reasonable truth—truth that stands the test of reason.

### Thinking Style: Past-Present Archetype: Weighing Implications Role: To Bring Care

The value of Weighing Implications lies in its ability to examine consequences given what has already been learned. With the weighing of truth done and the meaning of things known, the question is: What is the impact? What is going to have to change? With customary care, this archetype turns us around from looking for truth and meaning and asks us to look instead at future implications. It considers the historical context while playing the actuary of reality, purposely weighing consequences and outcomes. The possibly cynical attitude towards the value of change sometimes presented by Weighing Implications is a necessary check on overzealous hope—hope beyond hope. Its true gift is one of caring.

### Thinking Style: Present Archetype: Planned Execution Role: Maintaining Direction

The value of Planned Execution lies in its ability to make a plan and stick to it. Organizing the myriad of details and what is known into one clear, organized approach is its goal. Knowledge is power, and with what this archetype knows it can make things happen. It creates scenarios and plays them out—plan A, plan B, plan C—to ensure an idea sees the light of day. Planned Execution brings form and structure to ideas. Order is the word of the day. “Stick with the plan” is its mantra. Its true gift is one of creating harmony.

### Thinking Style: Present-Future Archetype: Implementing Change Role: Developing Fresh Approaches

The value of Implementing Change lies in its ability to weave the goals of a plan into reality. With the determination to see things get done and a savvy intuition of how to achieve goals, this archetype thrives on solving problems in order to execute the plan. The manager of change is both a realist and a bit of a dreamer. As a manager of change, Implementing Change is driven by the passion and relevance of the vision and the excitement of making it real. Its true gift is one of redefining order.

### Thinking Style: Integrated Archetype: Global Sense Role: Fostering Collaborative Bonds

The value of Global Sense lies in its ability to bring consensus. It is the glue of collaboration and the bridge between archetypes. It brings together all of the points of view into one moving, synchronous effort without necessarily playing the role of leader. Its innate sense of all the pieces of the human puzzle and how to meld them together, including the various personalities, makes Collaborative Bonds the hub of communication and collective endeavor. While rarely predisposed to launch off on its own, it will equally rarely miss the opportunity to bring collaboration to the forefront of a group's focus. Its true gift is one of support and leadership.

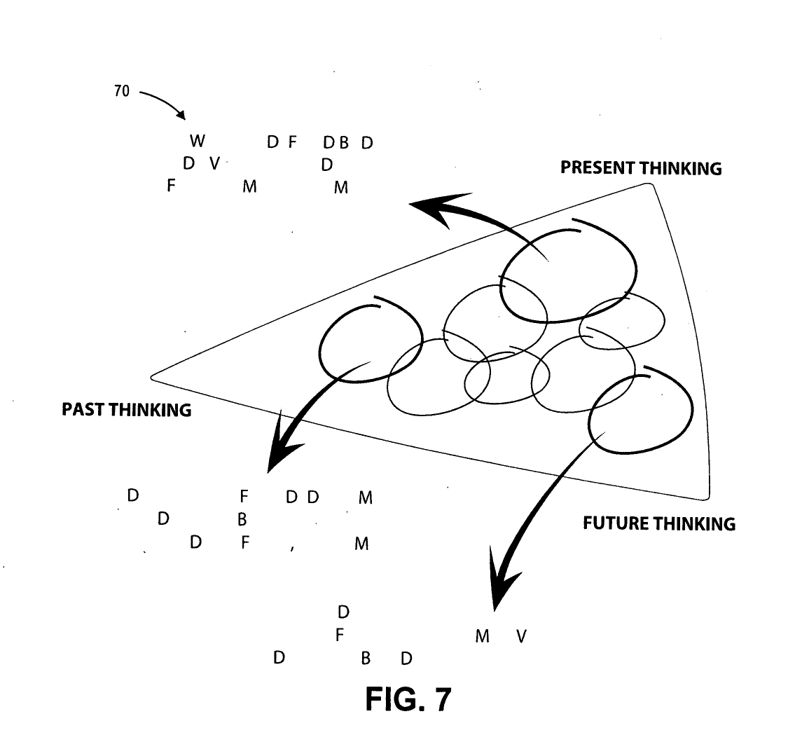

FIG. 7 is a schematic diagram 70 showing how more specific locations within the framework and within archetypical regions can be used to make more specific projections of how individuals behave in various scenarios.

Even within archetypical descriptions, observable differences in either relative or absolute intensity can be used to fine tune descriptions, and the nature of the model allows for specific projections across a wide range of the human experience. Learning the thinking style of a market or audience tells one the why and how behind the “who, what, when, and where.” When this revolutionary insight into people's needs, motivations and decision-making process is provided, one gains the power to communicate more effectively to them at all levels of engagement.

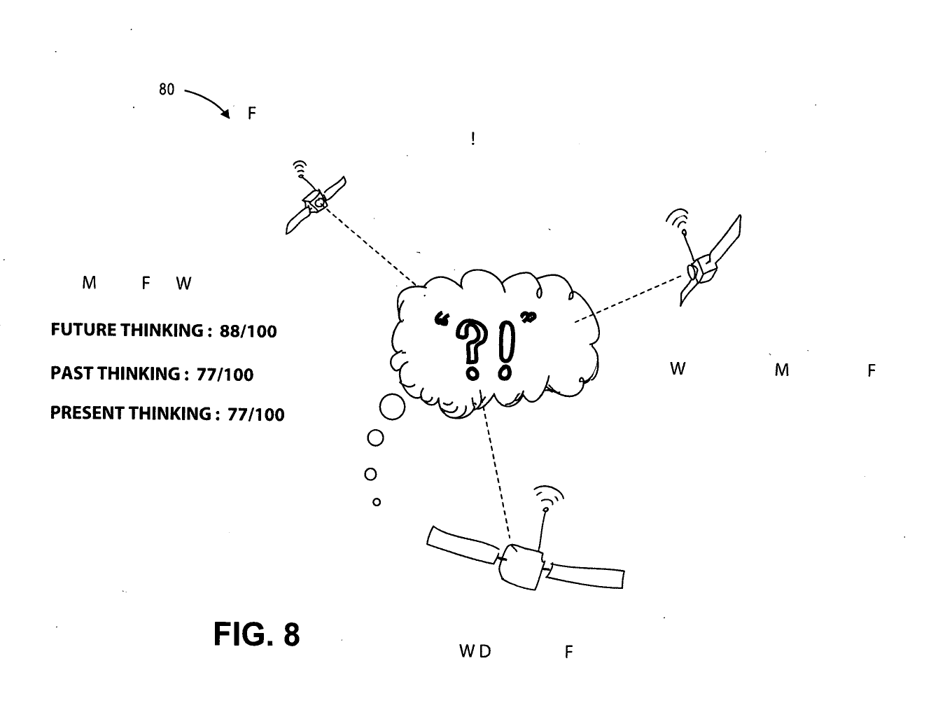

FIG. 8 is a schematic diagram 80 that shows how the invention locates people in time with scientific accuracy.

In an embodiment in just four minutes, the scientifically validated, proprietary technology embodied in a preferred embodiment sometimes referred to as “GPS for the Mind™” accurately measures the influences of Future Thinking, Past Thinking, and Present Thinking individually within people. It is these three measurements that allow people to be located within the map of the world of thinking, just as places can be located in physical space by triangulating signals from GPS satellites.

“Of the hundreds of profiles I have taken and been trained on MindTime® is the most effective and has the highest face validity” (Randy Austad, a profiling expert and author of The Call).

Measurements can be made by people responding to survey items validated to correlate with the foundational concepts of Future, Past and Present thinking, as in the GPS for the Mind module (which measures absolute intensity in each of the three constructs), and can also be made by inference by observing traits that correspond to the construct definitions for Future, Past and Present thinking, and also be reverse engineering specific locations and intensities by correlating them to the observed behaviors of individuals who have been previously located within the framework.

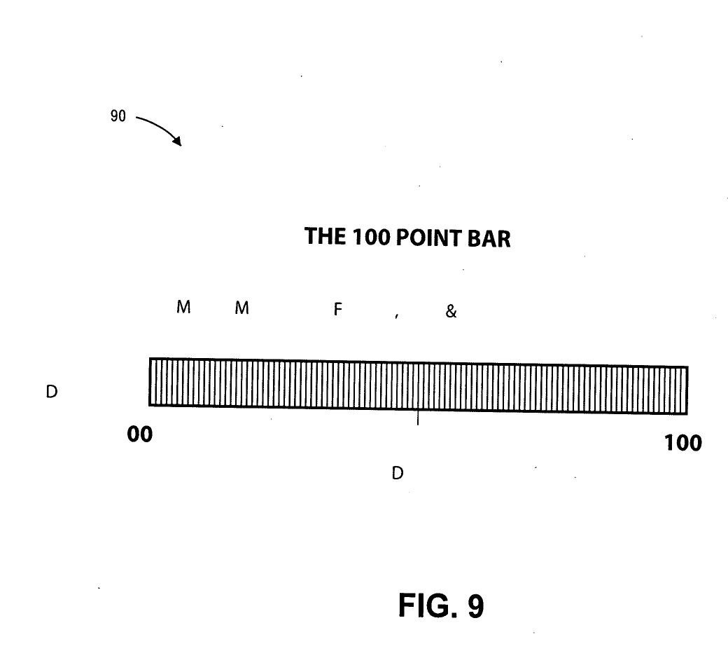

FIG. 9 is a schematic diagram 90 showing how absolute or relative intensities can be measured accurately based on a user's self-assessment.

The numeric results from any measurement are converted into either of the measurement profiles displayed in FIG. 2, whether of absolute measurements in each construct or through measurements of their relative intensities, and those intensities are taken to the coordinates for the person or object within the framework.

The same method may be used with linguistic or conceptual measurements, which may be estimated to have a numerical equivalent for the purposes of mapping.

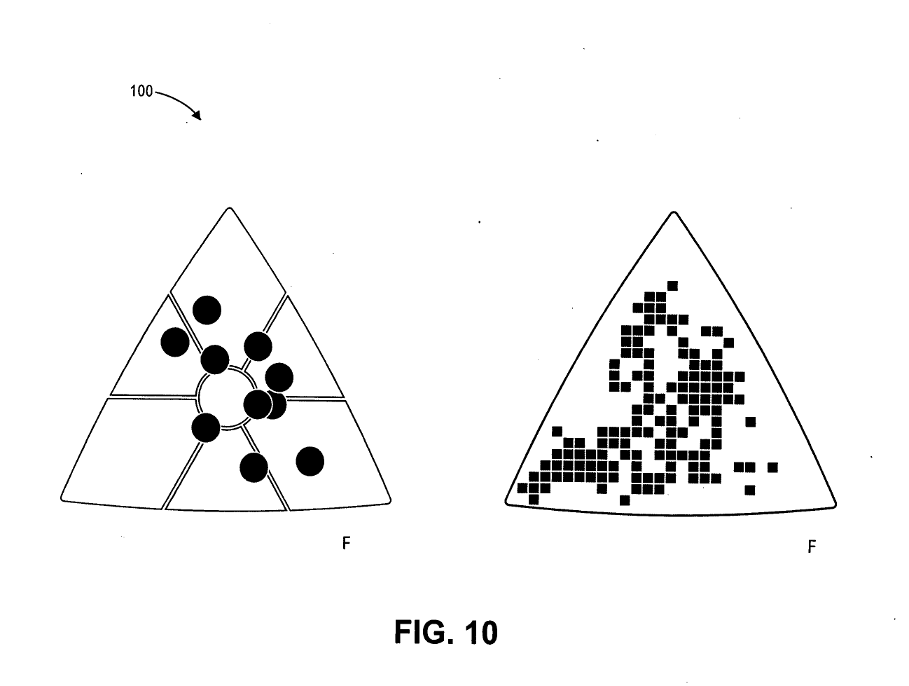

FIG. 10 is a schematic diagram 100 showing how two or more individual locations in the framework can be represented together to show the range of temporality of a group.

By looking at the full range of temporal influence for a group of people, or of people who share any common trait, it is possible to see how that group or that trait holds different meaning for different people, and how each person is likely to behave in relation to each other will differ.

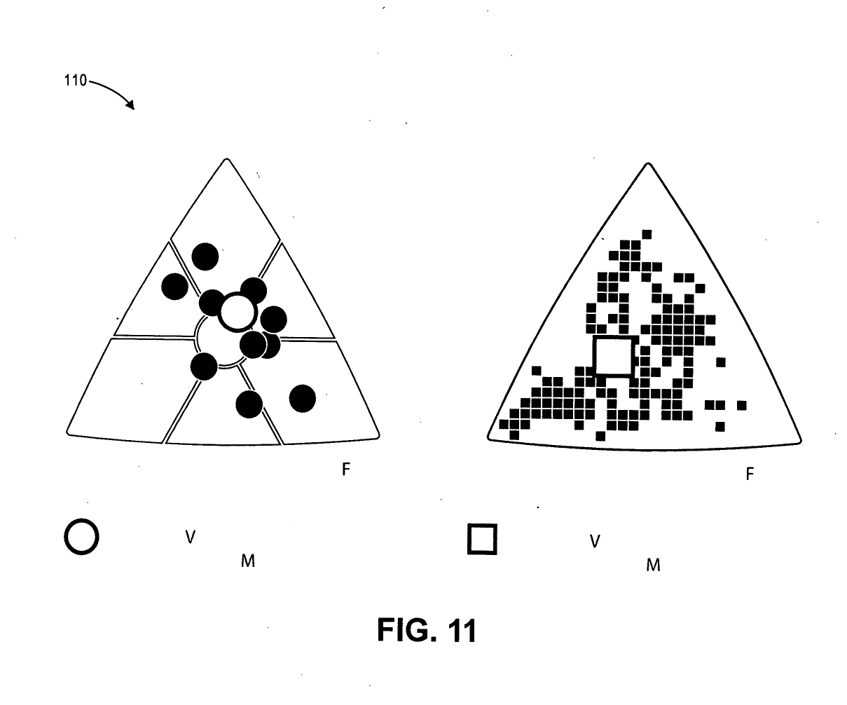

FIG. 11 is a schematic diagram 110 showing how two or more individual locations in the framework can be represented by a single aggregate coordinate.

This makes is easy to visualize multiple large groups within the framework, and also to attach group characteristics to a single coordinate either relative or absolute. This is especially useful when identifying the temporality of an object, opinion, or behavior, where the more people whose results are aggregated the more accurate of the shared trait will be.

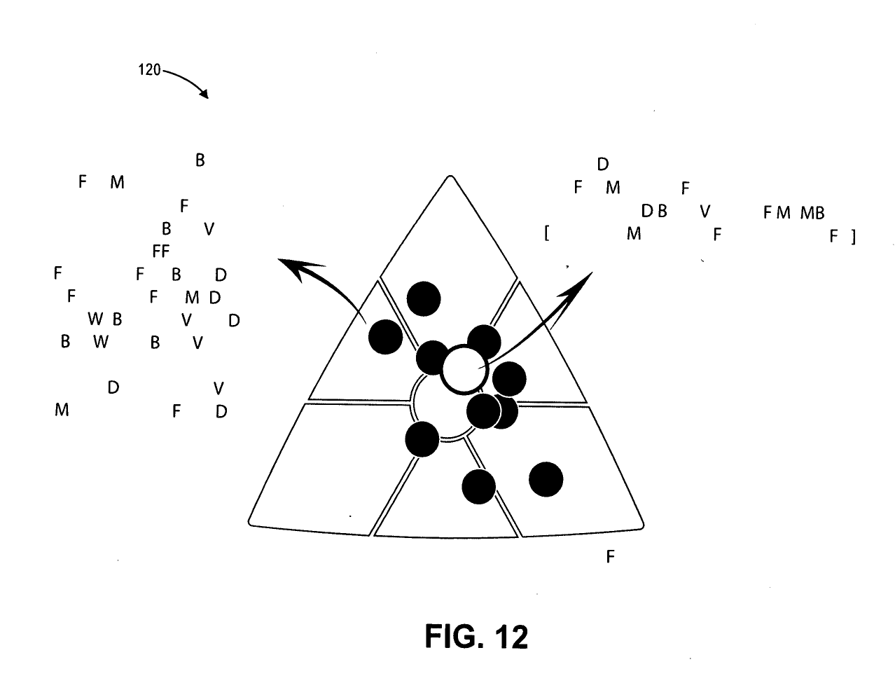

FIG. 12 is a schematic diagram 120 showing how all information about a person's life can be attached to their location in the framework.

Whenever there are absolute or relative intensity measurements for a person or a group, information is attached to the numerical or linguistic values for those absolute or relative intensities. Information can include but is not limited to job titles or descriptions, job performance, product or media preferences, usability ratings for Web sites, where people live or other demographic information, search or purchase histories or patterns, etc. Any information located in the framework becomes attached to that location as a unique data point, allowing all information located within the framework to be compared equally regardless of whether it was attached to a single person or to a group of people.

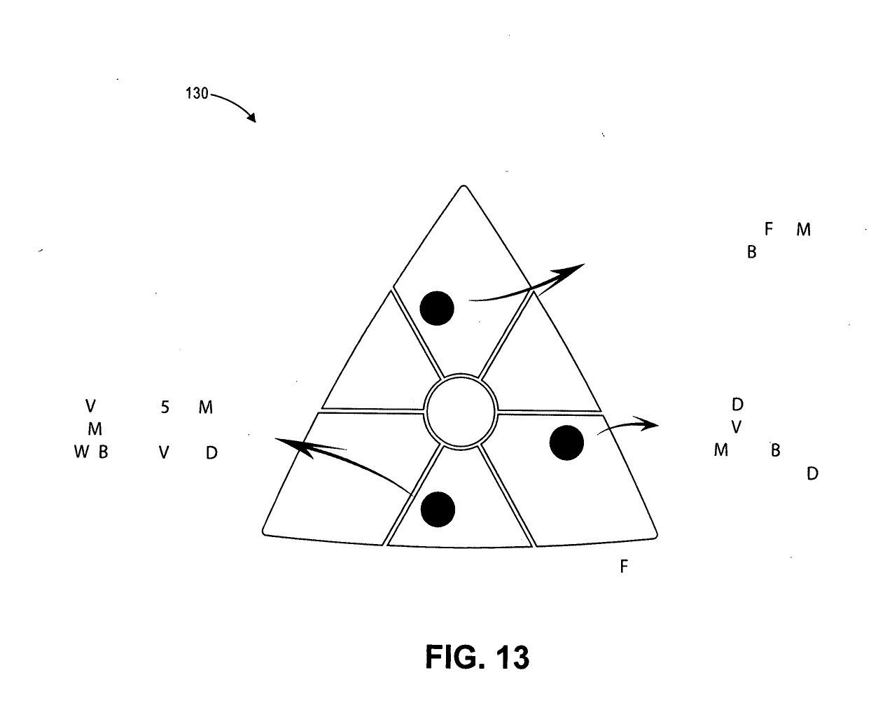

FIG. 13 is a schematic diagram 130 showing how additional data about individuals, or their behaviors, thoughts, opinions, perceptions, etc. can be better understood through its relationship to the temporal framework.

When a particular piece of information about a person, such as their high performance as a bank teller, is overlaid on top of the framework, it becomes easy to see what about that person is contributing to their high performance. These projections are always more accurate when made with the knowledge of an individual's absolute intensity vales.

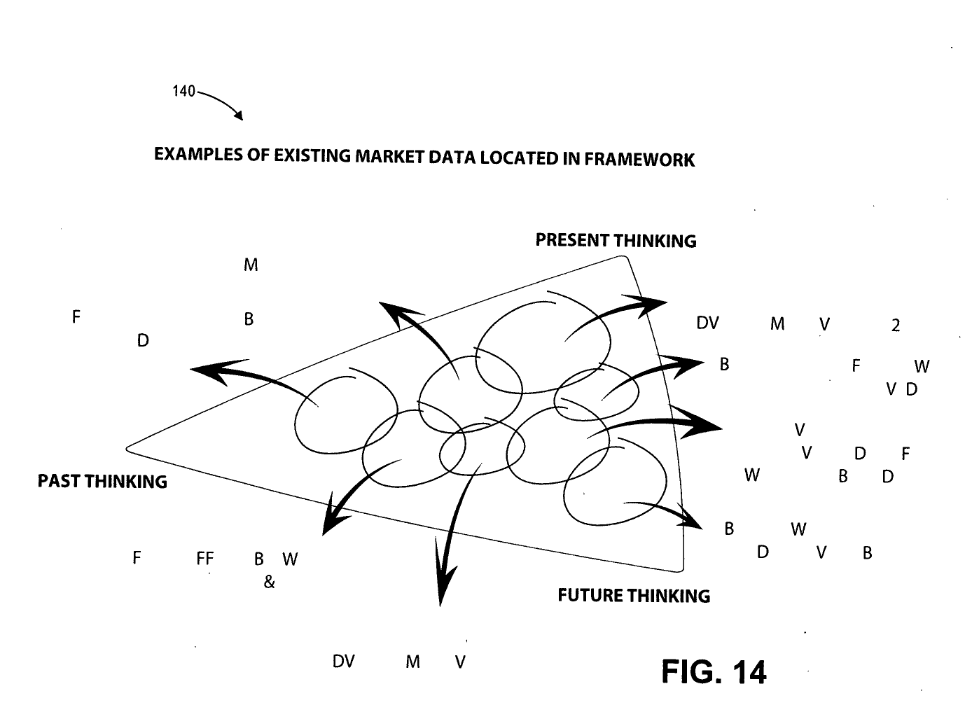

FIG. 14 is a schematic diagram 140 showing how additional data about people can be aggregated within the framework.

When a particular piece of information about the behavior, preferences, opinions, etc. of a group or people are associated with similar areas of the map, it can help identify specific blends of thinking influence that are most relevant when dealing with a specific group of people.

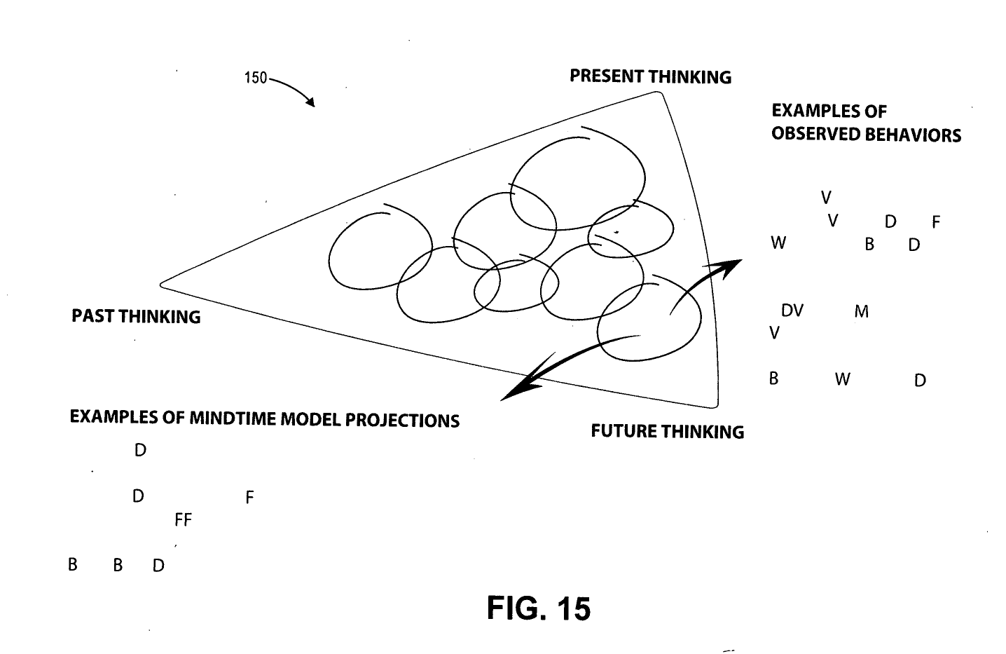

FIG. 15 is a schematic diagram 150 showing how additional data can be associated together by proximal location within the framework, and also associated with descriptions or projections based upon relative or absolute intensities of Future, Past and Present thinking.

As behavior patterns become associated with different areas of the framework, the model can be used to shed insight into what is causing them on a mass scale, and those same behaviors can be used to improve descriptions and projections of behavior that the Theory of MindTime® is capable of applying in various scenarios.

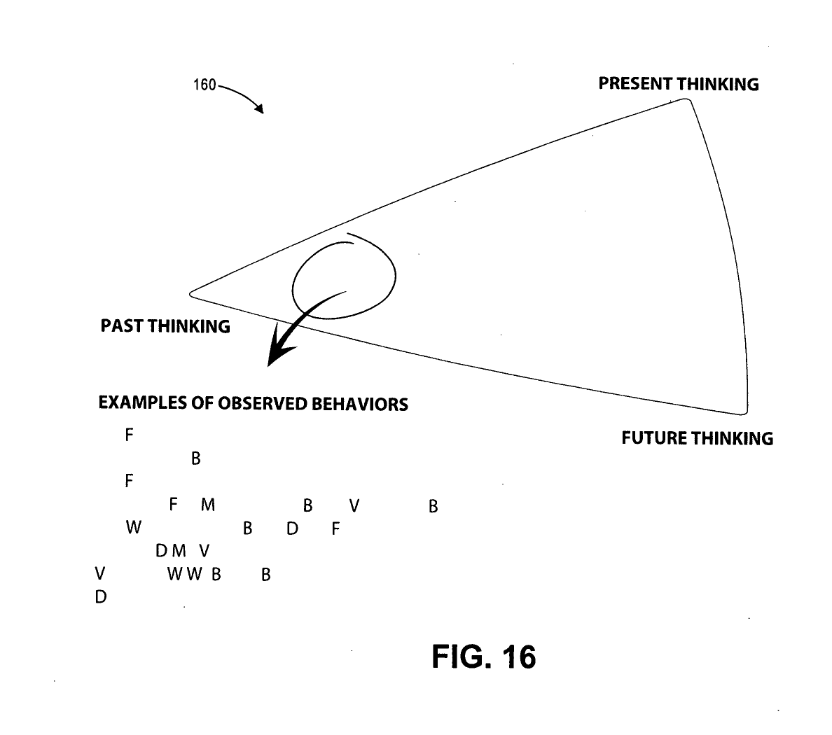

FIG. 16 is a schematic diagram 160 showing all manner of things correlated by the framework.

Any data with coordinates in the framework, by virtue of their association with people located in the framework, can be said to be associated because they appear in similar locations in the map or in similar ranges or categories of relative or absolute intensity.

For ease of aggregating lots of data, breaking the map up into graphical regions or quadrants is the presently preferred method. Items aggregated by proximity of absolute coordinates are more accurately associated.

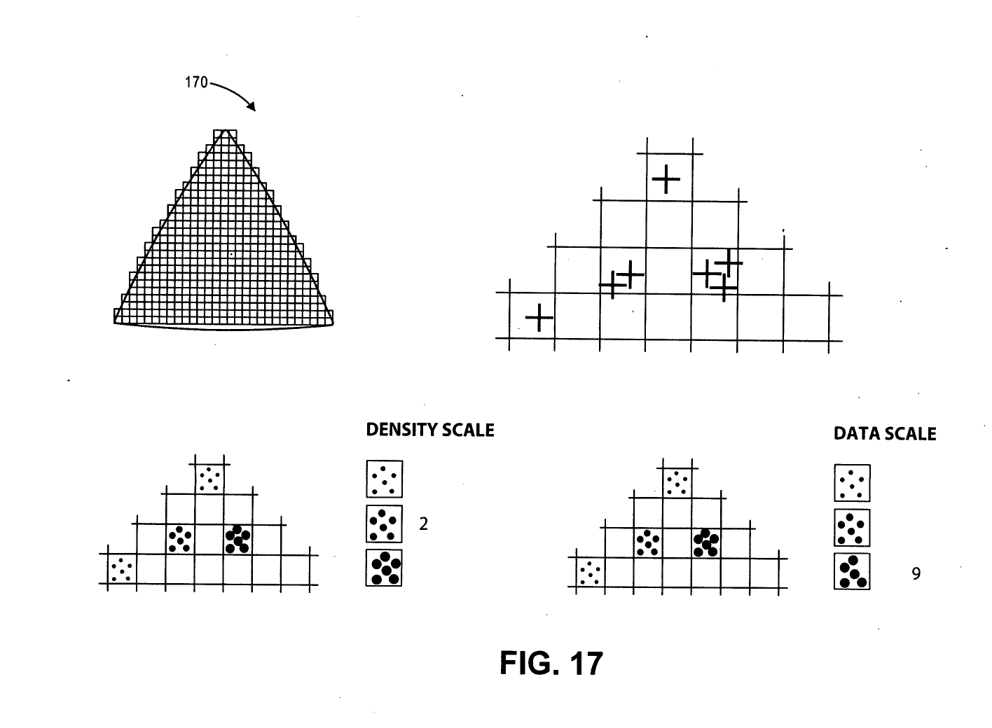

FIG. 17 is a graphic representation of a gradient map 170 according to the invention, allowing for color and density variations to depict data including but not limited to population of the square, intensity of preference ratings or other aggregation of data.

This method is useful for viewing large amounts of data where displaying individual points becomes difficult to read, or in applications where aggregating personal, group, and object data is desired. The gradient map is not limited by rectangular shapes, and is sometimes employed where each archetype region in the map (see FIG. 6) is used as a region to collect data.

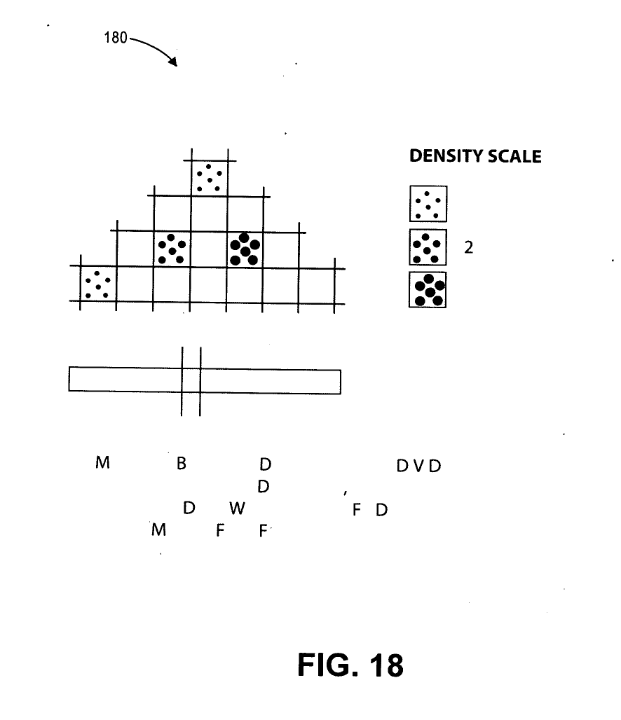

FIG. 18 is a graphic representation of a gradient map 180 according to the invention, showing how ranges of responses can be used to select who is displayed.

In this example, different quadrants of the map display only individuals whose preference rating for a particular item is in the 35-45 range.

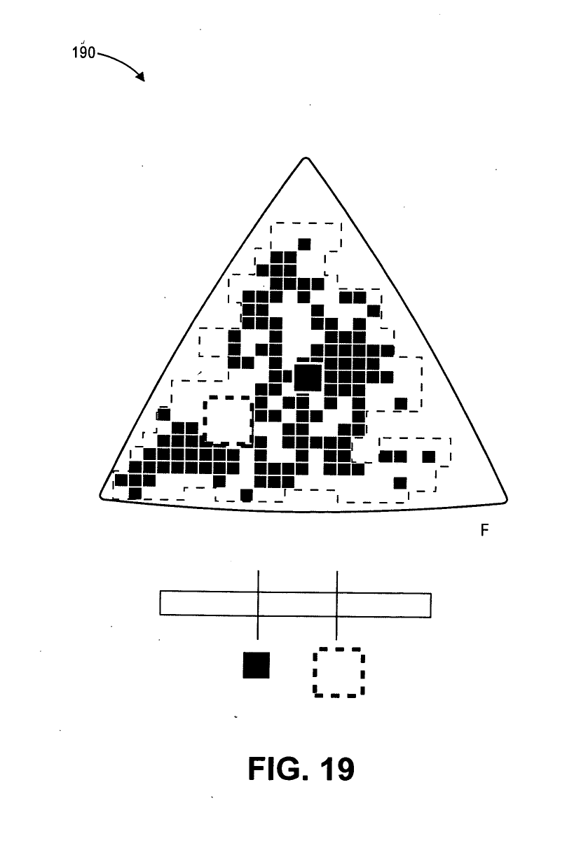

FIG. 19 is a schematic diagram 190 showing the total range of temporality of a group {by dashed line border}, the distribution of a subgroup {by dark region}, the aggregate location of the subgroup, with its average response to a stimulus item {the number 66, at its location}, and the location of a subgroup who responds at a preference level of 33 to the same stimulus item.

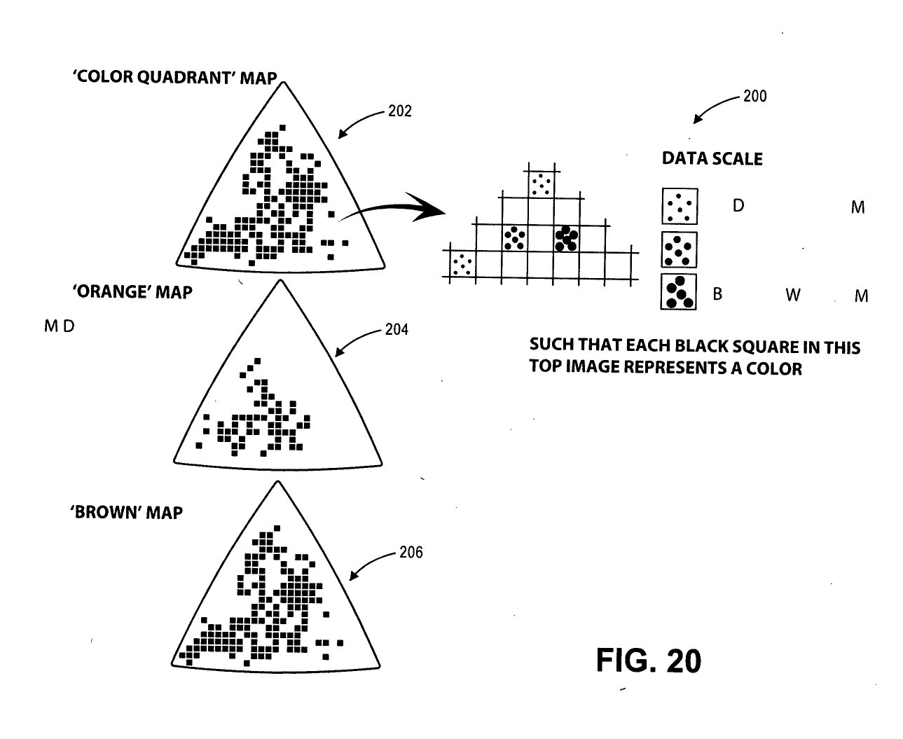

FIG. 20 is a schematic diagram showing a population of respondents {bottom map 206 labeled ‘brown’}, the population of only those responding with mild agreement to a preference survey {the middle map 204 labeled ‘orange’}, and the total population with color of quadrant representing the average response {top map 202 labeled ‘color gradient,’ with quadrants represented as ‘red’ representing high agreement and quadrants represented as ‘blue’ representing low agreement};

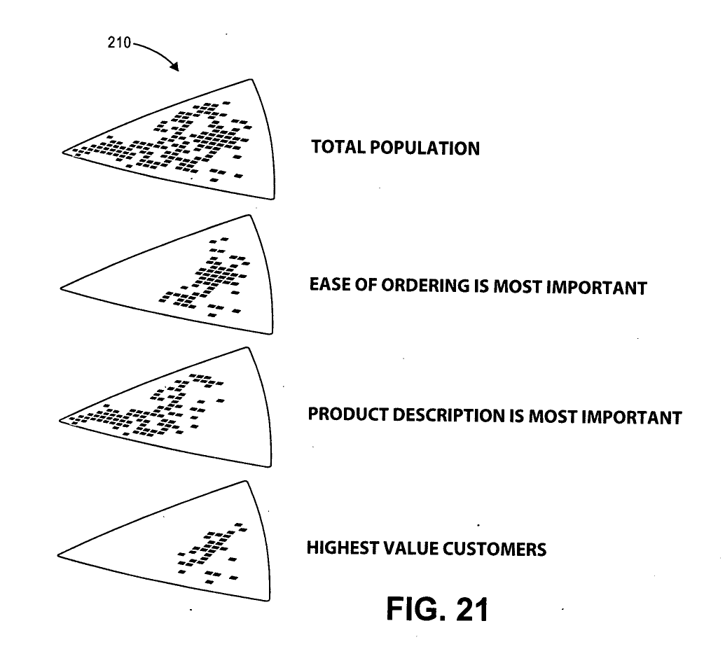

FIG. 21 is a schematic diagram 210 that shows how measuring people's thinking is the key to predicting their responses to products, services, and messages according to the invention.

Viewing all manner of behavioral data within the herein disclosed framework allows for the relationships between disparate data points to be clearly understood. For example, when you know not only what people are doing, and what behaviors are connected but also why and how they are doing it, you can more positively engage with people in all interactions.

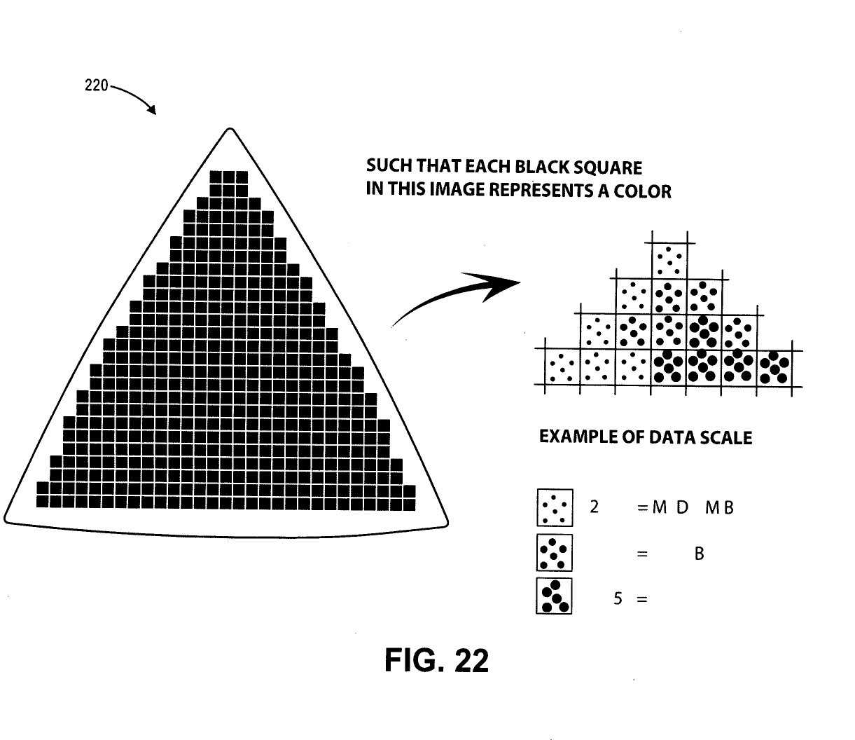

FIG. 22 is a schematic diagram 220 showing the predictive values for response to a stimulus item for all locations in the framework, based on the responses to that stimulus item of people who have been located in the framework.

In this map, the predictive values for a particular stimulus item are displayed. Predictions are correlated by regression analysis to the responses to that stimulus item by other people already located in the framework. In a presently preferred embodiment, areas of the map shaded red would indicate that coordinate location in the framework is contributing to a stronger positive response, green would indicate relative neutral influence of overall thinking perspective, and blue would indicate a negative correlation. Within the correlation between thinking style and preference (or any other numerical value), each one of the three thinking perspectives may have its own individual effect as calculated by regression: for example, high Future intensity may have a positive influence, Present thinking intensity may have no significant influence, and high Past intensity may have strong negative influence. Thus, a location related to strong Future and strong Past intensities may show no net effect (influences effectively canceling each other out), while a location related to strong Future intensity and weak Past intensity would have a strong positive influence (weak Past intensity indicating little effect from the negative-influence-to-Past-thinking correlation).

It is important to note that an accurate measurement of people's absolute intensities within the framework is required for accurate predictions.

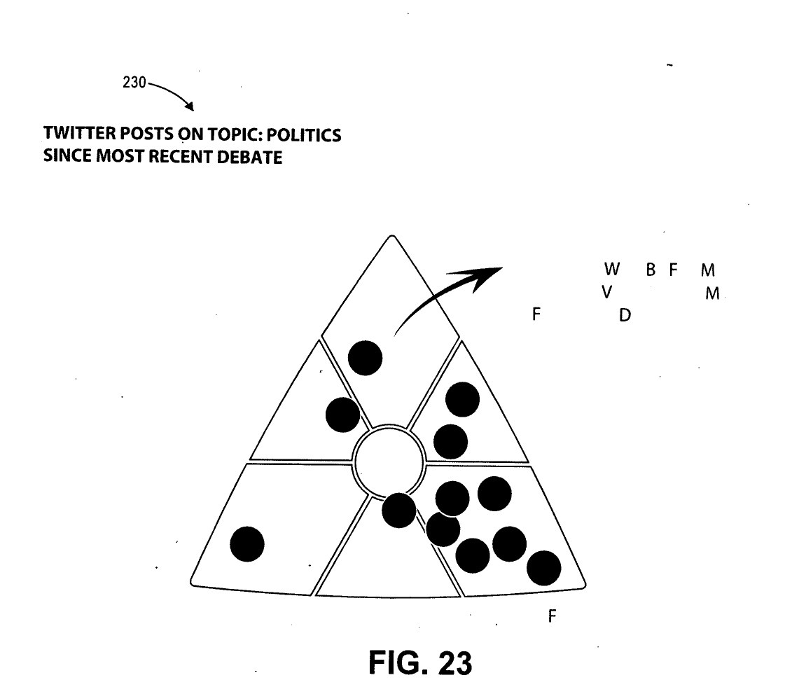

FIG. 23 is a schematic diagram 230 showing how any information online, including but not limited to blog posting or Twitter posts, can be found in a more meaningful manner by its association within the framework.

In this example, given a search for posts on a particular topic, the user can choose to look at content that has been posted by different kinds of people with different and identifiable world views, different and identifiable value systems, difference and identifiable communication styles, etc.

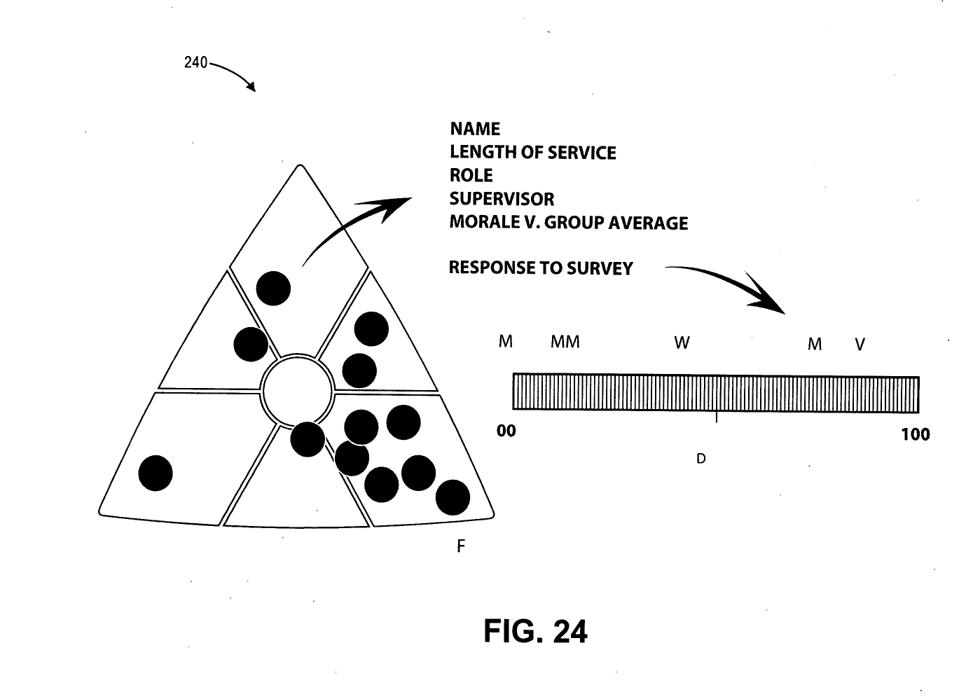

FIG. 24 is a schematic diagram 240 that shows the tying of thinking style to performance metrics according to the invention.

The herein disclosed model makes it possible to answer the basic questions about how people contribute to organizations with far greater certainty and predictability. The invention offers clear and concise insight into the roles people play, what they resist, how they collaborate, and how they need to be communicated with. Most importantly, it provides people with a measure of their own performance, empowering them to make the changes necessary to improve.

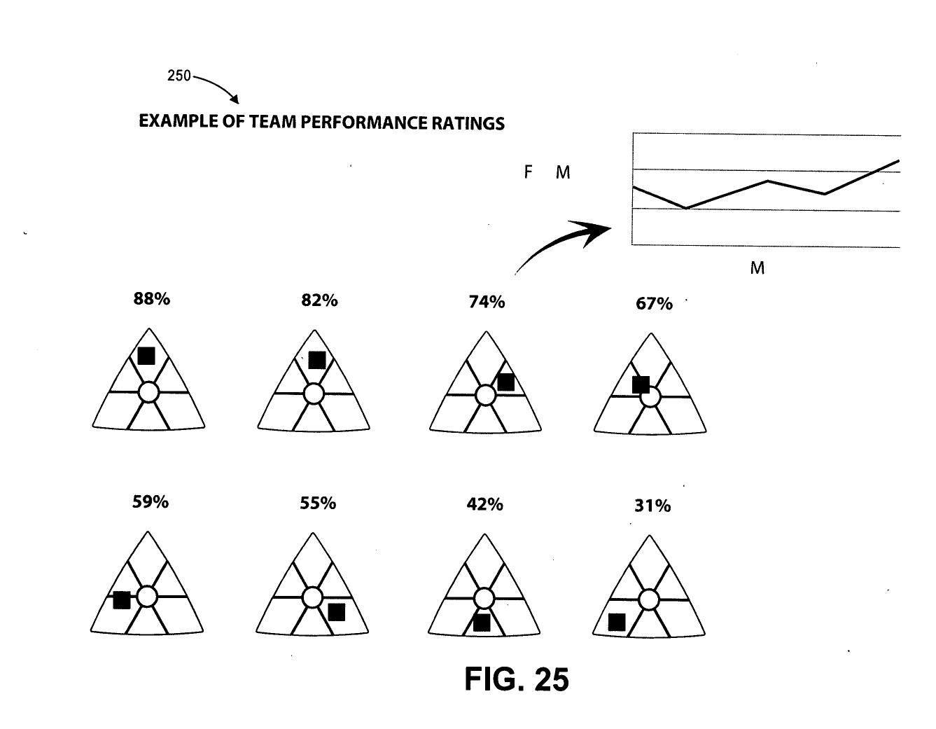

FIG. 25 is a schematic diagram 250 that shows the identification of optimal team dynamics to maximize performance according to the invention.

For teams that share a specific purpose within an organization there is an optimal thinking dynamic at play. This mix reflects the mental skills required to fulfill the team's goals. The invention provides powerful management tools to model optimal team makeup based on team performance data.

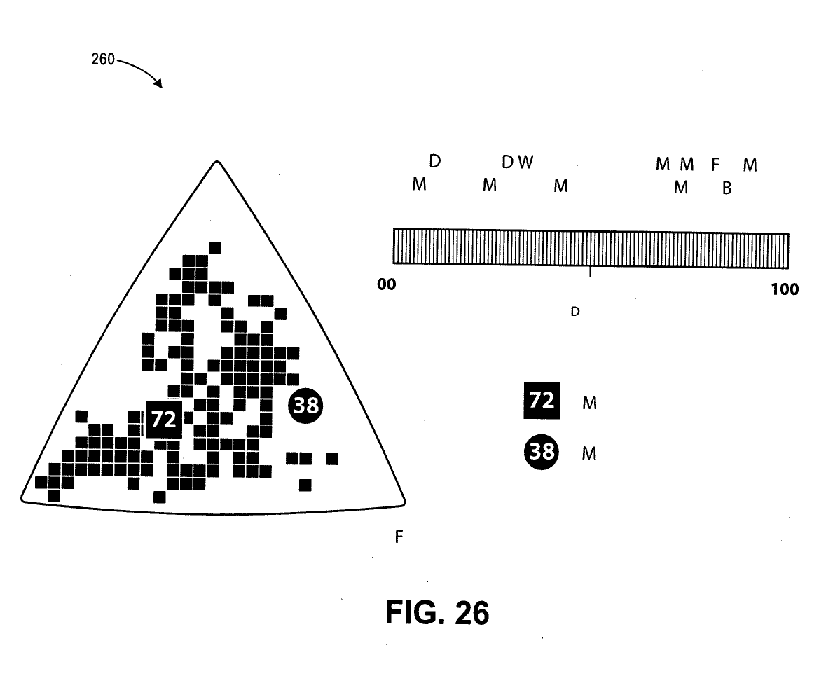

FIG. 26 is a schematic diagram 260 that shows organizational culture and team dynamics when mapped according to the invention.

Not only can the invention map people within the world of thinking, it can also correlate any other piece of information about a person with their location, including their opinions and beliefs. Among other things, this allows the herein disclosed technology to identify how buy-in on new ideas travels within an organization. By using the thinking styles to gain insight into the role, values, needs, motivations, and contributions of those who best and least understand organizational direction, the invention helps identify the processes needed and the best ways to communicate change management through an organization.

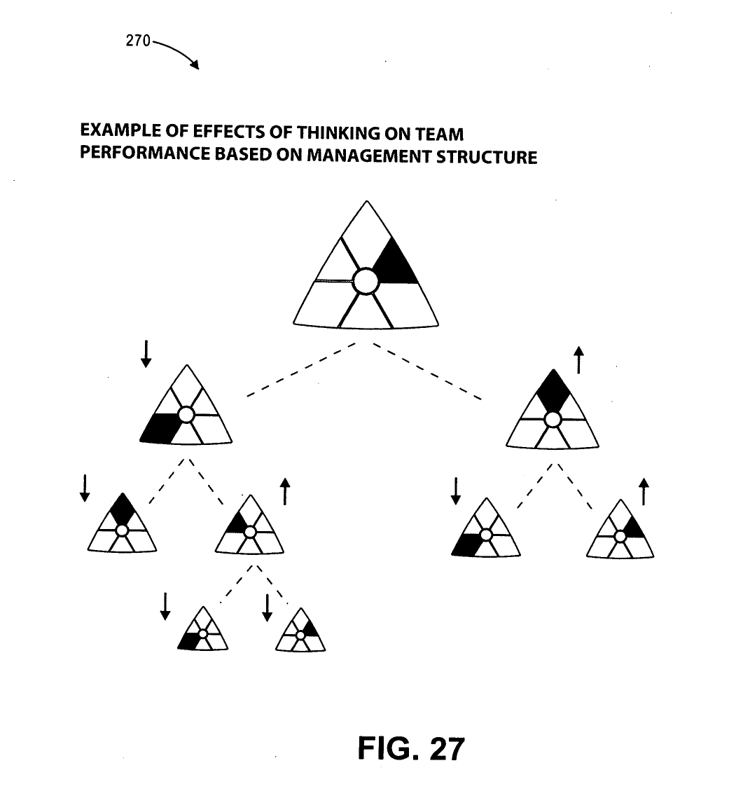

FIG. 27 is a schematic diagram 270 that shows monitoring organization-wide thinking and performance according to the invention.

An organization is a thinking system and there are many benefits derived from understanding it as a whole. Looking at an organization systemically allows for a far greater ability to forecast, monitor, and correct for issues. It provides base line performance metrics with which to measure the organizations overall health and performance. It also provides an early warning system that ensures that action is being taken by having managers aware of what is happening within their units.

### Software

The following provides pseudo-code examples of software modules that may be used to implement various features of the invention. In particular, examples are provided for:

(Pseudo-code 1) determining which of the set of 95 categories that is currently the most numerous way to break up ranges of coordinates an individual profile result belongs to by comparing the ranking and relative intensity of each of the three temporal constructs;
(Pseudo-code 2) locating a coordinate point (x,y) representing the profile of a person, thing, idea, behavior, etc. in the triangle based on the strength-of-spring method, size of the relevant triangle, and visualization factors for exaggerating relative locations so as to minimize overlap;
(Pseudo-code 3) mocking the map up into the particular number of rectangles we use to make a grid for the purpose of aggregating data based on the size of the relevant triangle and amount of corresponding data, assigning values—aggregate survey data, observed and assigned behavioral data, demographic data, etc—to each of the mocked up grids, and outputting the grids and corresponding data to a visualization, i.e. Web page);
(Pseudo-code 4) correlating responses to stimuli, or observed or projected behavioral data, or demographic data, or any other assignable qualities to the three main foundational concepts and predicting how new respondents react to the stimuli or match the other data based on their own coordinates within the framework;
(Pseudo-code 5) grouping individuals together based on non-thinking style criteria {belongs to this online group, has this role/job title, etc} representing each individual's profile based on (1) above and calculating the group average coordinates and representing that coordinate based on (1) above; and
(Pseudo-code 6) Color-Gradient Mapping: creating a color-gradient map to visualize the predictions of how different people respond to a given stimulus item based on their locations within the framework using (3) and (4) above.

### Hardware

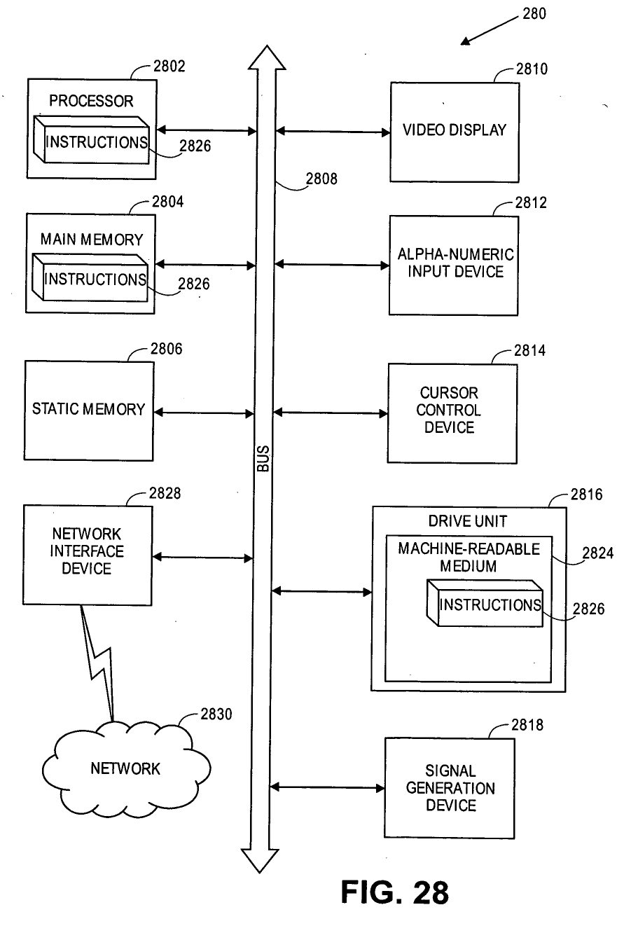

FIG. 28 is a block schematic diagram of a machine in the exemplary form of a computer system 280 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 280 includes a processor 2802, a main memory 2804 and a static memory 2806, which communicate with each other via a bus 2808. The computer system 280 may further include a display unit 2810, for example, a liquid crystal display (LCD) or a cathode ray tube (CRT). The computer system 280 also includes an alphanumeric input device 2812, for example, a keyboard; a cursor control device 2814, for example, a mouse; a disk drive unit 2816, a signal generation device 2818, for example, a speaker, and a network interface device 2828.

The disk drive unit 2816 includes a machine-readable medium 2824 on which is stored a set of executable instructions, i.e. software, 2826 embodying any one, or all, of the methodologies described herein below. The software 2826 is also shown to reside, completely or at least partially, within the main memory 2804 and/or within the processor 2802. The software 2826 may further be transmitted or received over a network 2830 by means of a network interface device 2828.

In contrast to the system 280 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

### Theory and Measurement of a Presently Preferred Embodiment

### Scientific Background and Overview

The ability to localize human experience temporally is considered to be one of the most important evolutionary advancements of consciousness in homo sapiens (e.g. Suddendorf and Corballis (1997, 2007). At about 1.5 million years ago, ancestors of modern humans developed the ability to: (a) dissociate mentally from primary perceptions and represent real world objects symbolically; (b) form secondary representations of objects, i.e. decouple primary representations from the present and place them into different temporal locations; and (c) develop symbolic representations (metarepresentations) of the relationships among secondary representations. Secondary representations allow real world objects to be represented mentally in multiple ways, such as how it is, how it was, and how it could be, whereas metarepresentations involve the ability to understand that a representation of an object or event is just that: a representation of an object, and that different representations of objects—one's own and/or others'—may all represent the same object.

As a result of the above, a new level of mental executive control was created that included the ability to engage in mental time travel (Suddendorf). Mental time travel involves the active reconstruction of both past and future events based on the information contained in both episodic and semantic memory and the ability to temporally locate those reconstructions as belonging to the past or to the future. That is, mental time travel involves the ability to mentally project oneself backward in time to recall past experiences and knowledge stored in memory or forward in time to envision future possibilities.

Mental time travel and memory. In brief, human memory systems have been conceptualized as consisting of two types—implicit and explicit memory. Implicit memory includes memories that do not involve active conscious reconstruction, such as procedural memory and memories formed as a result of associative stimulus-response learning (e.g., Tulving, 1985a, 1985b, 1993), whereas explicit (declarative) memory itself consists of two systems: semantic memory and episodic memory. Semantic memory refers to the recollection of facts and general knowledge that is not bounded by space or time and which provides the foundation for inferential and analytical reasoning, whereas episodic memory involves the recall or imagining of personal experiences and life events that are temporally located (Tulving, 1985a, 1985b). According to Tulving (e.g., 1993), both episodic and semantic memory are involved in mental time travel. On the one hand, episodic memory involves a temporal organization of unrelated events that allows a person to transport at will into the past as well as into the future. On the other hand, the act of retrieving past experiences and of extrapolating forward in envisioning future possibilities requires the active reconstruction and recoding of information stored in semantic memory.

In summary, mental time travel involves the ability to disengage from the present and actively reconstruct both past and future events based on the information contained in both episodic and semantic memory. Moreover, it also involves the ability to temporally locate those reconstructions as belong to the past or to the future.

### The Theoretical Model—The Theory of MindTime®

The inventors herein cite the three foundational tenets of the Theory of MindTime®:
(1) That three distinct sets of thinking perspectives evolved in concert with the ability of human beings to engage in mental time travel;
(2) Measurable individual differences exist in the extent to which individuals use the three thinking perspectives, and;
(3) The extent to which individuals use the three thinking perspectives, in combination, influences how they perceive and interact with the world.

It will be noted that the below summary and the scientific papers in full refer to the presently preferred scientific method for assigning values to individuals in the three constructs of the Theory of MindTime®—Future thinking perspective, Past thinking perspective, Present thinking perspective—as the TimeSyle™ inventory; and use the term TimeStyle™ profiles to refer to an exact location in the framework and/or a range of locations held together by a set of archetypical behavioral and thinking qualities as projected by the Theory.

### (1) The Three Thinking Perspectives

Overview. According to our model, each thinking perspective exists as a part of human consciousness because each had an important duty in ensuring the survival of the human species during the long process of evolution from our primate forebears. We propose that the ability to mentally time travel into the past to access past experiences and knowledge stored in memory and to perceive the products of those reflections as belonging to the self that exists in the moment of time referred to as ‘now’ corresponds with a pattern of thinking we refer to as Past thinking. Past thinking provided Homo sapiens with the ability to consciously access information that could minimize the risks involved when interacting with current and anticipated environmental and situational events. Conversely, the ability to mentally time travel into the future and to perceive such imaginations as belonging the self that exists in the moment of time referred to as ‘now’ corresponds with a pattern of thinking we refer to as Future thinking. Future thinking provided Homo sapiens the ability to creatively envision possible future scenarios, thereby increasing the ability to and adapt to anticipated ever-changing environmental circumstances. Finally, the ability to step out of time mentally and conceptualize and observe sensory input, mental processes, and behavioral output from the point of view of a self-aware observer corresponds with a pattern of thinking we refer to as Present thinking. Present thinking provided human beings with the ability to act as independent observers of their own actions and to integrate current needs with the products of Past and Future thinking. In summary, we believe that together—Future thinking, Past thinking, and Present thinking—provided an evolutionary advantage that allowed human beings to increase their chances of personal, social, and reproductive survival.

Past thinking. We use the term Past Thinking to refer to the pattern of cognitive skills that are associated with the ability to mentally time travel into the past. Past thinking involves, at its core, the thinking processes involved when individuals actively retrieve past experiences and knowledge stored in memory. These thinking processes include reflection, recollection, contemplation, and the active reconstruction and recoding of information stored in semantic memory. Thus, Past thinking involves the ability to actively search, reconstruct, analyze, and critically evaluate information stored in both episodic and semantic memory for its relevance to the current situation. These abilities provide an adaptive benefit that involves (a) the ability to differentiate between relevant and irrelevant experiences and knowledge and then to (b) select those experiences that best serve to minimize risk. Past thinking also involves the ability to identify when gaps in existing knowledge exist and additional information is needed. When such gaps in knowledge are perceived to exist, Past thinking involves the active search for additional information from other environmental and social sources. In summary, Past thinking involves the reflective capability of accessing past experiences and stored information as well as the ability to critically evaluate such information, identify gaps in knowledge and engage in an active search of new information.

According to the Theory of MindTime®, individual variation in Past thinking manifests as differences in the: (a) extent to which individuals engage in introspection, reflection, contemplation, analysis, and information gathering; (b) speed and confidence of decisions (Past thinking tends to manifest as slow decision making as well as the tendency to second guess those decisions); (c) extent to which individuals are sensitivity to the presence of negative environmental stimuli; and (d) extent to which individuals are cautious, skeptical, and cynical.

Future thinking: We use the term Future thinking to refer to the pattern of cognitive skills that are associated with the ability to mentally time travel into the future. Using episodic memory, Future thinking involves to the ability to creatively imagine an infinite set of hypothetical future scenarios emanating outward in time from the present moment. Drawing upon semantic memory, Future thinking involves the ability to see gaps in existing knowledge and of patterns and trends that diverge from prevailing schemas. Thus, Future thinking occurs when individuals engage in creative problem solving, divergent thinking, and the generative process of combining and recombining items into virtually infinite numbers of novel sequences. Future thinking is big picture exploratory thinking that is open-ended and not limited by preexisting conceptual and social schemas. Nor is it characterized by a presumption about which of all possible future possibilities ‘should’ or ‘must’ occur. From an evolutionary perspective, Future thinking facilitates adaptation to ever-changing environmental conditions and, consequently increases the probabilities for long-term personal and reproductive survival. In summary, Future thinking is visionary, innovative, creative thinking.

According to the Theory of MindTime®, individual variation in Future thinking manifests as differences in: (a) creativity, innovation, and visionary thinking; (b) the ability to perceive new opportunities in the environment; (c) the degree to which one is open to new experiences; (d) flexibility, adaptability, and an openness to change; (e) speed of decision making (Future thinking tends to manifest as quick and often seemingly intuitive decision making); and (f) the extent to which individuals are hopeful and optimistic.

Present Thinking. We use the term Present thinking to refer to the pattern of cognitive skills that are associated with the ability of the conscious mind to organize its own actions and mental states as well as manipulate the environment. Present thinking occurs when individuals integrate and organize the products of Past and Future thinking in order to execute the necessary behaviors that ensure immediate and long-term survival. Thus, Present thinking is thinking involving the organization of data and information into pre-existing conceptual schemas, the development of action plans based on that data, and the ability to organize resources to achieve those plans by the most efficient means possible. Such an ability is arguably unique to Homo sapiens and differs from the actions of other species that that largely operate as embedded environmental organisms without having an awareness of a unique sense of self.

In summary, Present thinking has two interconnected sub-domains: First, Present thinking is thinking that is oriented toward using the preexisting schemas that underlie all conceptual and social processes as the scaffolding by which it organizes and structures the world. It is this aspect of Present thinking that allows for the development of action plans and the ability to organize resources to achieve those plans by the most efficient means possible. Second, Present thinking is thinking that is oriented toward executing those action plans and getting things done.

According to the Theory of MindTime®, individual variation in Present thinking manifests as differences in: (a) the ability to organize, plan, and structure one's environment and activities; (b) individuals' tendency to adopt and maintain predefined social and personal schemas (e.g., rules, laws, procedures); (c) the extent to which decision making is based on expediency and pragmatism; and (d) the desire for stability, harmony, and the maintenance of good relations with others.

### Integration

At its most efficient, we believe that the human mind is constantly moving from one form of thinking to another in an orderly fashion. Information contained in memory and our conceptual schemas provides the scaffolding for Future thinking. It also provides the framework by which Present thinking can focus on structuring the environment in order to get things done. Future thinking, in turn, is focused on imagining possible variations of the future and the creative generation of ideas that can enhance personal adaptability. Past thinking can then be applied to validate those ideas against that which it already knows or seek out additional information to assist in the validation process. Once Past thinking identifies the most viable of ideas, Present thinking steps in to develop action plans and organizes resources to execute those plans. Even during this process, both Past and Future thinking can be utilized: Past thinking in order to evaluate the effectiveness of those plans or engage in analysis after the fact and Future thinking in order to envision and brainstorm alternative strategies and approaches that might be applied.

We also note that although all three thinking perspectives are hypothesized to have evolved together and in concert with the ability mentally time travel, and although we link each set of thinking skills to a particular temporal frame, each is inextricably linked to all three temporalities. First, all three thinking perspectives are oriented toward the future. Without the ability to conceptualize a future that has yet to occur, Future thinking could not occur. Similarly, without a sense of the existence of a personal future, individuals would not involve themselves in planning, organizing, and structuring the environment in order to control future outcomes. Finally, without an idea that a future exists and the motivation to minimize risk potential, knowledge stored in memory, whether of personal experiences, or personal or cultural knowledge, would be irrelevant. Future thinking is needed to facilitate adaptation to ever changing circumstances by imagining what possible circumstances or opportunities might be possible; Past thinking is needed to minimize risk by referencing what it knows to have worked (and what hasn't work) in the past in similar situations; and Present thinking is needed to integrate and organize the products of Future and Past thinking in order to maximize control and predictability of outcomes. In summary, human beings have the ability to mentally time travel into the future to envision future possibilities and into the past to access relevant past experiences and knowledge, so as to act in the present to ensure biological fitness in the future.

Second, all three thinking perspectives are grounded in the past: To engage in Future thinking, to begin to envision future possibilities, a conceptual framework of the existing world and how it operates must already exist. Thus, information contained in our memory stores and accessed by Past thinking provides the scaffolding upon which Future thinking can creatively innovate or imagine future outcomes. Conversely, Past thinking is, by definition, thinking that references past experiences and knowledge, and is oriented toward extracting meaning and relevance from those past experiences and stored knowledge. Past thinking naturally seeks to assimilate new information into existing schemas and/or accommodate existing schemas when confronted with new information that doesn't readily fit into those existing schemas. By engaging in these two processes, assimilation and accommodation, Past thinking is then able to apply its analytical insights to the thoughts and ideas generated by Future thinking and the action plans and organizational processes generated by Present thinking in order to assess the validity and viability of those ideas and plans. Finally, Present thinking, in order to organize and structure the environment and to develop action plans by which operate on the environment, also draws upon the preexisting conceptual schemas stored in memory. However, Present thinking is not concerned with the validity of those schemas and the information they contain; rather Present thinking is concerned with the organizing and structuring properties of those schemas in order to get things done. As new information is assimilated into conceptual schemas or as existing schemas are modified, Present thinking is able to integrate these changes into the action framework by which it operates.

Third, no matter what thinking perspective is being used, whether Future, Past, or Present thinking, such use occurs in the moment of time that is perceived of as ‘now’ (i.e. the present). For example, although Past involves mental time travel into the past, it does so by consciously directing one's attention or awareness, in the present, to the contents stored in memory. Likewise, although Future thinking involves mental time travel into the future, it does so by consciously directing one's attention or awareness, in the present, to envisioning future possibilities. Finally, Present thinking involves the conscious direction of attention, in the present, to activities that also occur in the present, such as making a shopping list or organizing data in a spreadsheet or measuring a piece of wood to be cut. Present thinking is considered present thinking, not because the thinking occurs in the present—all thinking occurs in the present—but because the activities associated with Present thinking occur are temporally located in the present. For example, making a shopping list may perhaps involve imagining possible menu's to prepare (Future thinking) and of recollecting particular memories of enjoyable meals (Past thinking), but the act itself of making the shopping list in a particular way—of organizing and listing ingredients and perhaps determine the stores to visit in order to purchase those ingredients is an action that occurs in the present.

### (2) Measurement

### Overview

According to the accepted theory of Darwinian natural selection, individual variation in abilities formed the foundation of natural selection with an important principle being that a species will exhibit variations in physical, behavioral, emotional, and cognitive characteristics. Over time, individuals who present characteristics that are adaptive for survival will be more likely to survive and pass those characteristics on to their offspring. Thus, variations in human characteristics can be understood as being a function of the process of evolution in which those characteristics that are most adaptive will increase the probability of survival. It is our supposition that three distinct thinking styles evolved in concert with the ability of human beings to engage in mental time travel because each increased chances of personal and reproductive survival. In addition, we posit that as a result of the same process, natural variations exist in the extent to which individuals utilize each of the three thinking perspectives and that these differences can be measured.

### Scale Development

The process of construct validation involves the following:
1. Formulating a theory regarding the focal construct by defining it constitutively.
2. Specifying the potential indicators of the construct.
3. Demonstrating that the set of observables measure the same thing (i.e., internal consistency estimates of reliability).
4. Demonstrating the extent to which scores on a measure derived from the set of observables of the intended construct correlate with scores on measures of constructs whose conceptual domains overlap.
5. Demonstrating the extent to which scores on a measure derived from the set of observables of the intended construct do not correlate with scores on measures of constructs whose conceptual domains do not overlap (divergent validity).

In the previous section, we described the Theory of MindTime® and the conceptual domains of Past, Present, and Future thinking. In this section, we (a) summarize the behavioral manifestations of Past, Present, and Future thinking from which we developed potential indicators of each, and (b) report evidence for the internal consistency and construct validity of the TimeStyle Inventory.

The Behavioral Manifestations of Past, Present, and Future thinking.

Table 1 provides a summary of the general characteristics and other behavioral manifestations of Past, Future, and Present and thinking.

TABLE 1
Personality characteristics and behaviors hypothesized to be
associated with each of the three thinking perspectives

| | Future Thinking | Past Thinking | Present Thinking |
|---|---|---|---|
| General | Active | Analytical | Action Oriented |
| Adjectives | Agreeable | Cautious | Conscientious |
| | Creative | Contemplative | Dependable |
| | Dynamic | Curious | Determined |
| | Extroverted | Cynical | Disciplined |
| | Energetic | Fair-minded | Doer |
| | Hopeful | Independent | Efficient |
| | Imaginative | Informed | Emotional Stable |
| | Impulsive | Introverted | Inflexible |
| | Ingenious | Judicious | Methodical |
| | Innovative | Neurotic | Organized |
| | Intuitive | Obsessive | Practical |
| | Inventive | Prudent | Pragmatic |
| | Open (to new | Reflective | Reliable |
| | experiences) | | |
| | Opportunistic | Reliable | Resilient |
| | Optimistic | Skeptical | Resourceful |
| | Resilient | Studious | Stable |
| | Spontaneous | | Structured |
| | Visionary | | |
| Type of thinker | Scattered thinker | Deep thinker | Deliberate thinker |
| Likes to think | New ideas | Abstract theories/the past | Practical information |
| about | | | |
| Thinks best by | Brainstorming with | Contemplating/reflecting | Planning/doing |
| | others | alone | |
| Mental energy | Quick and dynamic | Slow and reflective | Focused and |
| | | | deliberate |
| Nature of thought | Ethereal and flighty | Deep | Rhythmic and |
| | | | harmonic |
| Preferred working | Flexible and | Quiet and studious | Tidy and organized; |
| Environment | Dynamic; Few rules | | Functional and |
| | and regulation | | well-organized |
| Desk is | Complete chaos | Organized chaos | Neat and clean |
| Leadership Style | Inspirational and | Informational and | Managerial and |
| | charismatic | transformational | transactional |
| Communication | Ideas and metaphors | Verbose/Wordy | Direct and to the |
| Style | | | point |
| Persuades by | Articulating a Vision | Presenting well-informed and | Knowing how to do |
| | | cogent arguments | things |
| Approach to tasks | Starts more than can | Completes projects in plenty | Methodical and |
| | finish | of time | timely |
| Decision Making | Quick, intuitive, and | Slow and analytical; Based | Expedient and |
| | spontaneous; Based | on having the best | practical; Makes |
| | on best opportunity at | information available; | decisions by what |
| | the time; Based on | Agonizes over making a | best fits in with plans |
| | gut feeling | decision; tends to second | |
| | | guess oneself | |
| Learns best by | Trial and | Research/reading/observation | Reading |
| | Error/experimentation | | instructions/following |
| | | | a manual/doing |
| Creativity | Experimentation | Insight | Practice |
| Guided | Hope | Truth | Harmony |
| Seeks | Opportunity | Evidence | Control |
| Values | Change, creativity, | Authenticity, evidence, | Planning, control, |
| | flexibility, | fairness, history, accuracy, | continuity, stability, |
| | spontaneity, ideas, | knowledge, security | status quo |
| | innovation | | |
| Is Driven to | Explore | Validate | Organize |
| Oriented Towards | Change | Tradition | Status quo |
| Work or Career | Entrepreneur | Academic | Administrator |
| | Salesperson | Architectural Engineer | Civil engineer |
| | Deal Maker | Physician | City planner |
| | CEO | CFO | Accountant |
| | | | COO |
| Social Institution | Business | Academia | Government |
| Kind of Law | Litigator | Constitutional | Contract |
| Practiced | | | |
| Fears | Loss of Hope | Loss of Information | Loss of Control |
| Success defined | Ideas | Theories | Projects |
| by | | | |
| Love | Impulsive | Cautious | Realistic |
| Role | Innovator | Researcher | Planner |
| Focus Point | What could be | What was | What is |
| Key Question | What if? | Why? | How? |
| Drives | Change | Research | Order |
| Manipulates by | Persuasion | Withholding information | Control |
| Derives self- | Having ideas | By having ideas validated | Successfully executed |
| esteem by | celebrated | | plans |
| Known for | Ingenuity | Being informed | Resourcefulness |
| Needs | Options/open- | Information/data | Rules/Structure |
| | endedness | | |
| Lifestyle | Avant-garde | Traditional | Contemporary |
| Life appears | Random | Set in stone | Planned |
| Lives | Spontaneously | Cautiously | Practically |
| World View | Big Picture | Measured | Practical |
| Looks for | Opportunities | Meaning | Usefulness |
| Believes in | Possibility | Truth | Stability |
| Respects | Anarchy | Evolution | Status quo |
| Works best with | People | Data | Things |
| Guided by | Intuition | Rationality | Practicality |

Past Thinking. As stated in above, Past thinking involves: (a) the ability to disengage from the present moment in order to access past experiences stored in episodic memory through reflection and contemplation; (b) the active reconstruction of the past and recoding of information stored in semantic memory; and (c) the ability to analyze and critically evaluate both episodic and semantic memory stores for relevant information that can be applied to current behavior.

Because Past thinking is reflective thinking, individuals who rely primarily on Past thinking will likely be introspective, thoughtful individuals who prefer quiet and studious environments and not a lot of social stimulation. They are likely to prefer quiet times of contemplation in which they can reflect upon their ideas either away from other people or with a few like-minded individuals. Because Past thinking is associated with the stored memories of past experiences and knowledge, individuals who rely primarily on Past thinking will likely be cautious, skeptical individuals who show a natural resistance to new ideas and experiences.

The natural propensity for being cautious will manifest itself with respect to relationships (slow to commit and trust) and decision-making (slow but thoughtful decision making). However, Past thinking is also analytical thinking: people who use primarily Past thinking engage in research and information gathering—activities designed to validate new ideas, inform decision-making, and minimize risks. And because Past thinking is thinking that is focused on understanding the meaning associated with underlying patterns of information, Past thinking manifests itself as a concern for accuracy, authenticity, fair-mindedness, and truth. As a result, people who rely primarily on Past thinking are likely to take their time when completing projects, being more concerned with accuracy than with deadlines. In positions of leadership, people who rely primarily on Past thinking are likely to use their analytical minds and strong knowledge base to motivate, inform, persuade, and inspire others. Because of their concern with truth and fairness, people who use primarily Past thinking tend to be viewed by others as a person they can count on for knowing what they are doing, making informed decisions, and treating people fairly. They are likely to consult with others and listen carefully to myriad points of views, but always with an ear toward seeing how these other ideas fit into existing conceptual schemas. Chances are that people who rely primarily on Past thinking will likely support and use titles of office and position to clearly define people's authority, which in turn, is a reflection of trust.

With respect to social schemas, because Past thinking is thinking that is concerned with minimizing risks, there is a natural resistance toward change, especially when prevailing schemas have been found to be valid and meaningful. There is a natural skepticism of new ideas on the one hand, balanced by thoughtful analysis on the other: existing structures (laws, rules, etc.) and new ideas are often put through a rigorous validation process before they are adopted. Once adopted, these social and cognitive structures are rarely questioned unless prompted by some highly charged precipitating event—a death in the family; unemployment, social upheaval, etc,—that allows people to step outside the social or cognitive traditions under which they have become comfortable. When social and cognitive schemas are ultimately found to be without basis, people who rely primarily on Past thinking will tend to create new structures based on their own command of a large body of knowledge. Therefore, individuals who rely primarily on Past thinking tend to be viewed by others as traditionalists who are stubborn and resistant to change or as social troublemakers attempting to upset social conventions, depending on the extent to which the individual's sense of right and wrong are made salient. People who use primarily Past thinking are likely to gravitate toward occupations, such as academia, medicine, architecture, engineering, and law that have as an integral part of their job description research, analysis, and a heavy emphasis on validated bodies of knowledge. People who use primarily Past thinking are likely to gravitate toward occupations in which investigation, research, and knowledge are integral parts of the occupation. They are likely to be lawyers, scientists, academics, architects, architectural and aeronautic engineers, or rise to become Chief Financial or Information Officers.

In summary, Past thinking will manifest in people as the following personality traits: introverted, cautious, reflective and contemplative, curious, cynical, fair-minded, independent, judicious, skeptical, prudent, and analytical.

Manifestations of Future thinking. Future thinking involves the ability to imagine an infinite set of future possibilities emanating outward in time from the present moment and the speculative and creative ability to generate new ideas, possibilities, and solutions. Future thinking is visionary, creative, innovative and imaginative thinking that is open-ended and generative and involves connecting disparate bits of information in a way that can generate flashes of intuition and creativity.

Individuals who rely primarily on Future thinking perspective will likely be extroverted, creative, hopeful, and optimistic individuals who enjoy the free exchange of ideas, and therefore, the company of people. They are likely to be innovative and inventive and/or artistically inclined, depending on their unique background and skill sets. Because Future thinking is about seeing the big picture as it applies to future opportunities, a person who uses primarily their Future thinking will likely not limit themselves to any preconceived ideas about how the future ‘should’ or ‘must’ be. Rather, they are likely to manifest a high degree of flexibility and openness to new experiences and in exploring how the future can be. Thus, they are also likely to be naturally driven to explore and enjoy change. Their ability to creatively envision a variety of possible futures outcomes along with an openness to experience any or all of those outcomes will also likely manifest an inclination to act on perceived opportunities in a way that is largely free from predefined constraints. Thus, they also tend to prefer social, cultural, and work environments that have few rules and regulations or rigid forms of hierarchy. Such individuals are also likely to question the status quo. As a result, these individuals are likely to be viewed by others as non-conformists. Finally, their creative and innovative approach to life will also likely to manifest as a tendency of starting more tasks than they can finish and to until the last minute to focus their attention on completing a project they started. They are also likely to jump quickly into and out of relationships and to make quick decisions based on intuition. In the office, their desks are likely to be completely in chaos. As leaders, they are likely to be charismatic leaders who are able to articulate a vision discrepant from the status quo and who can mobilize and motivate individuals to achieve that vision through their strong persuasive skills.

With respect to social schemas, because Future thinking is thinking that involves seeing possibilities, prevailing schemas will likely be viewed as limiting, whether these schemas are systems of laws, explicit or implicit rules and regulations, or informal norms. As such, individuals who rely primarily on their Future thinking tend to be viewed by others as visionaries and innovators on the one hand, and non-conformists and troublemakers, on the other, depending on the social context and extent to which individual deviate from those norms. As indicated previously, they tend to prefer social, cultural, and work environments that have few rules and regulations or rigid forms of hierarchy, and may be viewed by others as non-conformist. Indeed, people who use primarily their Future thinking are likely to be viewed by others as change agents. People who use primarily Future thinking are likely to gravitate toward occupations in which leadership, change, and social interactions are integral parts of the occupation. They are likely to be entrepreneurs, salespeople, civil litigators, or rise to become Chief Executive Officers.

In summary, Future thinking will manifest as the following personality traits: creative, innovative, extroverted, energetic, hopeful, imaginative, impulsive, ingenious, intuitive, open to new experiences, opportunistic, optimistic, resilient, and spontaneous.

Manifestations of Present thinking. Present thinking is integrative thinking and involves the ability to generate action plans, organize the resources needed to execute those plans, and structure the environment accordingly. Thus, Present thinking is thinking that is concerned with organizing what is observed and what is known into patterns that allow for the most efficient means of developing and executing plans and with integrating the products of Past and Future thinking to ensure and increase the probability of present and future survival. Whereas Past thinking involves a reflection on past experiences and information and Future thinking involves an open-ended generation of hypothetical futures, Present thinking involves the structuring of current circumstances (including ideas, data, information, people, events, etc.) so as to maximize the probability of attaining one or more specific future outcome. In summary, Present thinking is concerned with controlling present and future outcomes.

Thus, individuals who use primarily their Present thinking tend to be very practical and organized individuals. Because their concern is with controlling future outcomes, they adopt a very orderly, structured, and goal oriented existence designed to achieve specific pre-defined outcomes. People who use primarily their Present thinking are likely to be highly conscientious, dependable, and reliable—almost to a fault. They tend to use their time in a highly efficient way, tending to plan out all of their activities in advance. Such individuals will be viewed by others as natural organizers and those whom others to turn to when something needs to get done: they have the ability to easily organize their own lives, the lives of others, as well as their environment and work place. They prefer to work in and create environments that are structured and organized; for example, at work or at home, their desks and living space will be neat and tidy—each thing having being properly stored after use. They will likely make lists and refer their lists frequently and will tend to complete tasks diligently and methodically, usually completing tasks right on time. They tend to be oriented toward the status quo and to be viewed by others as rigid and inflexible, adhering to rules and regulations without question. Conversely, they will also be rather resilient and stable, not easily rattled or upset. (i.e. emotionally stable). People who use primarily their Present thinking are likely to communicate with others in a way that is direct and to the point—that is, their communication patterns mimic their thought patterns—the focus is on pragmatism and functionality. As leaders, their focus is largely pragmatic with a managerial style that is likely to be oriented toward methods, policies, procedures, rules and regulations that are functional and expedient. They are also pragmatic, making decisions that are based on expediency and what best fits in with their plans. They desire stability, harmony, and maintaining good relations with others; and have a tendency to abhor chaos and confusion, with a corresponding drive to establish order and create structure.

Regarding social schemas, because Present thinking is thinking that is concerned with the immediate task of survival, people who rely primarily on Present thinking tend to take all existing schemas for granted. Such schemas will be assumed to be valid, or else they wouldn't exist, an attitude that is demonstrated by the statement “That's the law, so there must be a good reason for it.” The reason itself is irrelevant. The fact that the law is in place implies that it must work. Thus, for individuals who rely on Present thinking, laws, rules, and regulations will be viewed a priori as appropriate and necessary, whereas individuals who rely on Past thinking, for example, question those laws, rules, and regulations to determine their validity. People who use primarily Present thinking are likely to gravitate toward occupations that involve high levels of organization, planning, and execution. They are likely to be accountants, civil or industrial engineers, or rise to become Chief Operations Officers.

In summary, Present thinking will manifest as the following personality characteristics: conscientiousness, dependability, determined, disciplined, efficient, emotionally stable, inflexible, methodical, organized, practical, pragmatic, reliable, resilient, resourceful, and structured.

### Scale Development

The development and examination of TimeStyle items involved an iterative process across several studies. An initial pool of items was generated based on the hypothesized conceptual domain articulated above. Coefficient alpha estimates of reliability and principle axis analyses with varimax rotation were computed to narrow down the list of items to those having the best psychometric properties. In each set of studies, the psychometric properties of the items retained in each previous set of studies was studied, as well as the language and content of each item, to assess whether to include or revise an item. In addition, as data was analyzed and examined, additional items were generated for further examination. The goal was to derive a set of items that best represents the content domain of Past, Present, and Future thinking.

Psychometric findings. We have identified a final set of construct valid sets of items that index adequately the construct domains of Future Thinking, Past Thinking, and Present Thinking, and do so largely orthogonally. These items are displayed in Table 2.

TABLE 2
The TimeStyle Inventory

Item
Identifier

Validated Future Items

| | |
|---|---|
| Future 1 | I like to generate ideas. |
| Future 2 | I am known for generating ideas. |
| Future 3 | I thrive in environments that are flexible and dynamic. |
| Future 4 | People think of me as a visionary |
| Future 5 | I am known for invention/innovation. |
| Future 6 | I tend to make spontaneous decisions. |
| Future 8 | I am comfortable with change. |
| Future 9 | I am regarded as an agent of change. |
| Future 10 | I am always on the lookout for new opportunities. |
| Future 11 | My life is spontaneous. |
| Future 12 | I am quick to jump at opportunities. |
| Future 13 | I manage others through inspiration. |
| Future 14 | People think of me as dynamic. |
| Future 15 | I am open to spontaneity. |
| Future 16 | I like to keep my options open. |
| Future 17 | I value spontaneity. |
| Future 18 | When making decisions, I rely on intuition. |
| Future 19 | People think I am best at innovation and invention. |
| Future 20 | I am driven to explore. |
| Future 101 | I am open to future possibilities. |
| Future 102 | I can easily accept change when it happens. |
| Future 103 | I am able to inspire others with my vision. |

Additional Future items being tested

| | |
|---|---|
| Future 32 | I like to work in environments in which there are few rules |
| | and regulations. |
| Future 34 | After making a decision, I don't think about it anymore. |
| Future 35 | I usually wait until the last minute before completing |
| | things. |
| Future 104 | I tend to make quick decisions. |
| Future 105 | I usually dive into things headfirst |

Validated Present Items

| | |
|---|---|
| Present 1 | Being organized is important to me. |
| Present 2 | People think of me as organized. |
| Present 3 | People think of me as structured. |
| Present 5 | I thrive in environments that are orderly and structured. |
| Present 4 | People think I am best at planning and organization. |
| Present 6 | I prefer to work in a tidy environment. |
| Present 7 | I like making lists. |
| Present 8 | My preferred working environment is well thought out |
| | and functional. |
| Present 9 | I make lists of things to do or buy (for example, when |
| | going shopping). |
| Present 10 | People think of me as a follow through kind of person. |
| Present 11 | I am driven towards order |
| Present 12 | I am known for getting things done. |
| Present 13 | I enjoy getting things done on my list. |
| Present 14 | If I have a list of things to do, then I feel compelled to |
| | get them all done. |
| Present 15 | My style of motivation is to set the agenda. |
| Present 16 | I always feel the need to finish what I start. |
| Present 20 | I need structure |
| Present 23 | I manage my time well |
| Present 27 | I manage others by organizing/prioritizing tasks. |
| Present 102 | I am good at organizing resources to get things done. |

Additional Present items being tested

| | |
|---|---|
| Present 12 | I feel more comfortable taking action with a plan than |
| | without one. |
| Present 17 | If I leave a task unfinished, I usually can't stop thinking |
| | about it. |
| Present 19 | I tend to make practical decisions. |
| Present 22a | I usually schedule my time so that I can complete things |
| | with plenty of time to spare |
| Present 29 | When making decisions; I am usually guided by what fits |
| | best with my plans. |
| Present 101 | Before I start something, I usually plan it out first. |
| Present 104 | I am usually the one who is concerned about maintaining |
| | harmony when in a group. |
| Present 105 | When I'm part of a group, it's important to me that |
| | everyone is in general agreement when making a decision. |

Validated Past Items

| | |
|---|---|
| Past 1 | I often think about past experiences |
| Past 2 | I tend to dwell on “what was” |
| Past 3 | After making a decision, I agonize as to whether it was the |
| | right one |
| Past 4 | I like to reference the past. |
| Past 5 | I often wish I could go back and fix past mistakes. |
| Past 6 | I often think about past decisions |
| Past 7 | I agonize over making the right decision. |
| Past 8 | Only when I have all the facts do I feel comfortable making |
| | a decision. |
| Past 10 | Past experiences strongly inform my decisions. |
| Past 101 | I tend to second guess myself. |
| Past 107 | I am cautious by nature. |

Additional Past Items being tested

| | |
|---|---|
| Past 9 | I gather as much information as possible before making |
| | a decision. |
| Past 11 | I usually listen carefully to all arguments before forming |
| | an opinion about something. |
| Past 12 | I like to reason things out. |
| Past 13 | I like to think things through before making a decision. |
| Past 14 | I need to verify information before accepting its validity. |
| Past 15 | I reflect on the facts before making a decision. |
| Past 16 | When making a decision, I hesitate when I feel I don't have |
| | all the facts. |
| Past 17 | I weight the evidence before coming to a conclusion. |
| Past 23 | I often take a long time making decisions. |
| Past 31 | I don't like to manage others; I'd rather do my own thing. |
| Past 34 | I am a very skeptical by nature. |
| Past 102 | I need to have proof before I commit to something. |
| Past 104 | I tend to think things through carefully |
| Past 105 | I need to know the meaning of things. (asked to delete this |
| | on Mar. 23, 2009) |
| Past 107 | I am cautious by nature. |
| Past 109 | I need to understand the risks involved before committing |
| | to something. |
| Past 112 | If I have to make a quick decision before gathering all |
| | the information I need, afterwards I |
| | usually agonize over whether it was the right one. |
| Past 113 | I tend to analyze things thoroughly before making a |
| | decision. |
| Past 116 | It's important for me to understand the reason's ‘why’ |
| | before committing to something. |
| Past 119 | I will do my research before forming an opinion about |
| | something. |
| Past 120 | I think before I act. |
| Past 121 | I usually reflect carefully on what I know to see how it |
| | applies to the current situation. (asked to add this on |
| | Mar. 23, 2009) |
| Past 122 | I usually reflect carefully on what I know before making |
| | a decision. From Mar. 23, 2009) |
| Past 124 | Past experiences guide my decision making. (from |
| | Mar. 23, 2009) |
| Past 125 | When I don't know something, I will seek out additional |
| | information before making a decision. |

### Evidence for the Construct Validity of the Scales

Fortunato and Furey (2009, 2010a, 2010b, and 2010c) reported evidence supporting the reliability and construct validity of the TimeStyle Inventory. See Table 3 for a summary of this evidence.

TABLE 3
Construct Validity
Summary of Results Showing Convergent and Discriminant Validity Coefficients from Fortunato and Furey
(2009: S1), Fortunato and Furey (2010a: S2), Fortunato and Furey (2010b: S3), and Fortunato and Furey
(2010c: S4).

| | Future | | | | Past | | | | Present | | | |
|---|---|---|---|---|---|---|---|---|---|---|---|---|
| | S1 | S2 | S3 | S4 | S1 | S2 | S3 | S4 | S1 | S2 | S3 | S4 |
| Big Five | | | | | | | | | | | | |
| Personality | | | | | | | | | | | | |
| NEO - | −.11 | | | | .43** | | | | .12** | | | |
| Neuroticism | | | | | | | | | | | | |
| NEO - | .37** | | | | −.11** | | | | .07 | | | |
| Extroversion | | | | | | | | | | | | |
| NEO - | .00 | | | | −.13* | | | | .09* | | | |
| Agreeableness | | | | | | | | | | | | |
| NEO - | .37** | | | | .01 | | | | −.10** | | | |
| Openness | | | | | | | | | | | | |
| NEO - | .04 | | | | −.03 | | | | .65** | | | |
| Conscientiousness | | | | | | | | | | | | |
| Time Perspective | | | | | | | | | | | | |
| TPI Future | | −.02 | | | | .16** | | | | .65** | | |
| TPI Past | | .09** | | | | .13** | | | | .16** | | |
| Positive | | | | | | | | | | | | |
| TPI Past | | .00 | | | | .58** | | | | .06 | | |
| Negative | | | | | | | | | | | | |
| TPI Present | | .43** | | | | .04 | | | | −.15** | | |
| Hedonistic | | | | | | | | | | | | |
| TPI Present | | .07 | | | | .13** | | | | −.16** | | |
| Fatal | | | | | | | | | | | | |
| Miscellaneous | | | | | | | | | | | | |
| Personality | | | | | | | | | | | | |
| Resiliency | | | .47** | | | | −.10* | | | | .38** | |
| Optimism | | | .25** | | | | −.30** | | | | .22** | |
| Cynicism | | | −.08 | | | | .24** | | | | −.10* | |
| Type A | | | .41** | | | | .08 | | | | .29** | |
| Personality | | | | | | | | | | | | |
| Hardiness | | | .37** | | | | −.14** | | | | .22** | |
| Aggressive - | | | .13** | | | | .10* | | | | −.06 | |
| Physical | | | | | | | | | | | | |
| Aggressive - | | | −.04 | | | | −.18** | | | | −.10* | |
| Verbal | | | | | | | | | | | | |
| Aggressive - | | | .08 | | | | .−05 | | | | −.19** | |
| Anger | | | | | | | | | | | | |
| Aggressive - | | | −.09* | | | | .39** | | | | −.08* | |
| Hostility | | | | | | | | | | | | |
| Overall | | | .02 | | | | .22** | | | | .15** | |
| aggression | | | | | | | | | | | | |
| Thinking Style | | | | | | | | | | | | |
| Legislative | | | | −.21** | | | | .04 | | | | −.21** |
| Executive | | | | .42** | | | | .50** | | | | .42** |
| Judicial | | | | .36** | | | | .25** | | | | .36** |
| Hierarchical | | | | .02 | | | | .25** | | | | .02 |
| Oligarchic | | | | −.20** | | | | .21** | | | | −.20** |
| Monarchic | | | | .44** | | | | .29** | | | | .44** |
| Anarchic | | | | .13* | | | | .02 | | | | .13* |
| Global | | | | −.05 | | | | −.10 | | | | −.05 |
| Local | | | | −.13* | | | | .39** | | | | −.13* |
| Internal | | | | .46** | | | | .16** | | | | .46** |
| External | | | | .65** | | | | −.02 | | | | .65** |
| Liberal | | | | −.32** | | | | −.06 | | | | −.32** |
| Conservative | | | | −.21** | | | | .48** | | | | −.21** |

*p < .05;
**p < .01
Notes:
S1 = Fortunato and Furey (2009);
S2 = Fortunato and Furey (2010a);
S3 = Fortunato and Furey (2010b);
S4 = Fortunato and Furey (2010c).

### (3) Profiles

### TimeStyle Profiles

In the sections above, we described (1) the Theory of MindTime® and the provided descriptions of Past, Future, and Present thinking, and (2) the development of the TimeStyle Inventory. As previously indicated, the extent to which individuals use each of the three thinking perspectives, alone and in combination, influences the manner in which they perceive and interact with the world. We described the behavioral manifestations of Past, Future, and Present thinking, those descriptions are limited to individuals who use primary their Past, Future, and Present thinking perspectives respectively.

However, another critical aspect of the Theory of MindTime® is that the degree to which individuals use each of the three thinking perspectives, in combination, provides the greatest predictive validity when examining an individuals' behavior and personality. We refer to this ‘combination’ of thinking perspectives as one's TimeStyle Profile.

According to our model, each individual uses Past, Future, and Present thinking in various degrees. Thus, profiles can be generated based on how individuals score on each of the three measures.

In one presently preferred embodiment used to simplify the description of how the three thinking perspectives interact, there are ten core TimeStyles or archetypes: Future, Past, Present, Future-Present and Present-Future blends, Future-Past and Past-Future blends, Past-Present and Present-Past blends, and Integrated, each manifesting a specific set of behavioral and psychological characteristics, which we refer to as Tempo. Thus, a person's Tempo is the behavioral and psychological manifestation of a particular TimeStyle. However, these ten TimeStyles have an almost infinite number of variations, of both greater and fewer number, based on the individuals' specific scores on the TimeStyle Inventory.

The placement of individual's scores reflect the intensity with which they utilize each of the three thinking perspectives and the relative placement of each of these scores in relationship with the others reflects the relative intensity of individuals' scores. Thus, the intensity of any particular thinking perspective refers to the extent to which an individual uses that thinking perspective, whereas relative intensity refers to the extent to which an individual uses each thinking perspective relative to the others. For example, a person with a ‘Future’ TimeStyle is someone who scores substantively more highly on the Future thinking scale than on both of the Past and Present thinking scales and thus, favors their Future thinking perspective. Conversely, a person with a Past-Present TimeStyle is someone who scores about equally on both the Past and Present thinking perspectives and much higher on both of those scales than on the Future thinking scale. (Note that a person with Past-Present TimeStyle is someone who scores slightly higher on Past thinking dimension than on the Present thinking dimension, whereas someone with a Present-Past thinking style is someone who scored slightly higher on the Present thinking dimension than on the Past thinking dimension.)

In addition to the above, within each of the core TimeStyles, we posit that it is possible to discern relative differences based on the intensity of people's scores. For example, although two individuals who scored about the same on all three thinking perspectives would be classified as having an ‘Integrated’ TimeStyle, differences would still be observed based on the intensity of individuals' scores. On the one hand, one individual may score quite highly on all three scales, whereas another individual might score only moderately on all three scales. The behavioral and psychological characteristics expressed by both individual should differ.

In summary, it is our supposition that each individual is capable of Past, Future, and Present thinking, but uses these capabilities differently.

In summary, we articulated the following:
(1) The Theory of MindTime® including descriptions of the three thinking perspectives (Past, Future, and Present thinking);
(2) The development of the TimeStyle Inventory; and
(3) The behavioral and personality manifestations associated with each of the three thinking perspectives as well as the point of view that the extent to which individuals utilize each of the three thinking perspectives, in combination, i.e. TimeStyle Profile, influences the manner in which they perceive and interact with the world.

### APPLICATIONS

The invention may be applied for any purpose that aims to better understand human beings or the products of the minds or labors or general life facts of human beings, given the below summation of the features of the invention:

Ability to accurately locate a person within the temporal framework.

Calculate the coordinates (three, numbers) of a person within the temporal framework through the administering of a statistically significant temporal locating survey (with one presently preferred survey consisting of 18 statistically correlating items) or through other means.

Represent a person's temporal coordinates on a two-dimensional, triangular plane.

Represent a person's temporal coordinates by graphical means, i.e. color, intensity graphs, iconographic representation.

Segment temporal locations into archetypical categories. Segmentation can happen in any combination of groupings, with some presently preferred segmentation groups of 3, 4, 7, 10, and 95.

Forecast insights, descriptions, characteristics and other values of an archetypical category based on the theory of the primary temporal constructs for any given archetypical region.

Develop insights, descriptions, characteristics, and other values of an archetypical category based on the provided, observed, and otherwise obtained attributes of the people, groups, and objects that occupy said archetypical region.

Provide insight and analysis about a temporal location based on the precise coordinates (three numbers) or archetypical grouping. Insight and analysis includes but is not limited to communication style, relationship behavior, leadership capacity, resistances, decision-making ability, values, learning style, primary motivator, and view of the world.

Represent two or more people's temporal coordinates on a two-dimensional, triangular plane.

Represent two or more people's temporal coordinates by graphical means.

Compare the temporal locations of two or more people. Comparisons can occur mathematically, statistically, psychologically and representationally to name a few.

Compare individual temporal coordinates (just past, or present or future) of two or more temporal locations to determine the degrees to which each coordinate has more or less of one quality, attribute, characteristic, etc associated with that temporal value.

Provide insight and analysis about the temporal locations of two or more people.

Create temporal coordinates for the group (two or more people) by averaging the temporal coordinates of all members of the group.

Represent the group's temporal coordinates on a two-dimensional, triangular plane.

Represent the group's temporal coordinates by graphical means.

Provide insight and analysis about a group's temporal coordinates.

Represent multiple groups' temporal locations on a two-dimensional, triangular plane.

Represent multiple groups' temporal locations by graphical means.

Provide insight and analysis about multiple groups' temporal coordinates.

Project and apply any form of personal information, i.e. demographic information, physical attributes, survey results, opinions, written feedback, etc, to that person's temporal coordinates.

Project and apply the combination of aggregate information of a discrete group of people to that groups' temporal coordinates, given each person in the group has provided said information.

Project and apply a specific sub set of the combination of aggregate information of a discrete group of people to temporal coordinates of the corresponding sub set of individuals meeting the information criteria. For example, people in a specific organization who respond highly (80-100) on a certain survey item.

Describe the level of agreement (low degree of standard deviation) or disagreement (high degree of standard deviation) on specific issues within archetypical groupings of peoples temporal coordinates.

Describe the level of agreement or disagreement on specific issues within the combination of archetypical groupings of peoples temporal coordinates and any combination of other segmenting information (demographic or otherwise).

Measure and interpret the level of agreement or disagreement on specific issues within the archetypical groupings of people's temporal coordinates.

Measure and interpret the level of agreement or disagreement on specific issues within the combination of archetypical groupings of people's temporal coordinates and any combination of other segmenting information (demographic or otherwise).

Measure the influence of the temporal values of an archetypical grouping of peoples temporal coordinates on the level of agreement or disagreement on specific issues.

Project the level of agreement or disagreement a person will have on a specific issue based on their temporal coordinates.

Project the proportional relationship between the temporal coordinates of a person based on their level of agreement or disagreement on a specific issue.

Project the intensity level of any single or combination of temporal coordinates of a person based on their level of agreement or disagreement on a specific issue.

Observe and record behaviors (consumer patterns, search history, physiological attributes, psychological tendencies, etc) of temporally located individuals to project temporal values to the observed behaviors.

Represent the temporal values of an observed behavioral value on a two-dimensional, triangular plane.

Represent the temporal values of an observed behavioral value by graphical means.

Compare the temporal coordinates of two or more observed behavioral values.

Produce a temporal value for two or more temporally located observed behavioral values.

Project an individual's temporal coordinates upon observing their behavior and comparing the observations to catalogued and processed temporally located observed behaviors (consumer patterns, search history, physiological attributes, psychological tendencies, etc).

Refine archetypical descriptions through real-life observation of individuals located in the framework, to better describe foundational behaviors as well as to create descriptions for more specific individuals and scenarios.

The framework provides a method for how to move information through a thinking system so as to optimize the value and outcome of the information.

The framework can be used in whole or in part as a main or supporting element to a metric built upon pre-existing information about individuals or upon another to-be-discovered or favored dimension for understanding people, e.g. a dimension of being ‘in your head’ vs. being ‘in your body.’

One skilled in the art will readily appreciate how these features apply to applications that include but are not limited to:

Determining job description, job skill requirement and job fit for hiring; increasing workplace efficiencies; improve CRM performance and satisfaction; creating cohesion among individuals and resolving disputes between individuals work, social, political or other settings; maximizing investment in human capital; determining optimal team make-up by assuring that all thinking skills are represented; understand, predict and improve job performance; objectively understand and compare job performance ratings, forecasting group potential; predicting impediments to success in any group of people either by determining what mental capacities are not in evidence among them, and/or determining what mental capacities will be relied upon too heavily in avoidance of other unique and essential mental capacities; communicating to people in all circumstances, including but not limited to company policy, teaching in classrooms or online, advertising and marketing materials, or the real or projected benefits and problems with political policy; matching students with the educators who are best able to teach them; change management within both companies and communities {e.g. convincing people to change their energy consumption habits in the face of changing resource availability, or to change their fiscal consumption and saving habits in the face of changes in economic conditions, or to become more charitable to those less fortunate, or to understand how their actions impact others they are personally unfamiliar with}; predicting local, national or world economic events; predicting local, national or world cultural trends; understanding the similarities and differences between differing religious beliefs; designing products to meet user needs; designing rewards programs for frequent customers; determining what products to buy for what people; determining in what markets a product should be introduced; understanding group or community opinion on any subject; determining the exact relationship between the opinions or behaviors or different individuals or groups; predicting how two or more people will relate to each other; matching individuals together for dating; understanding the value of the perspectives of people who are different to create a sense of community among disparate people; reducing political or social turmoil; improving online search by directing people to Web sites and products that are most applicable to their temporal needs; motivating individuals and groups; understanding brand sentiment and driving brand behaviors; advertising to the core values of the audience for any product or service; writing better instruction manuals; increasing empathy among customer service employees and improving customer relations of all kinds; predicting the people's preferences of all kinds, including but not limited to Web sites, blogs and other media online or off, art, music, political opinions, products, the behaviors, character and values of other people and groups, and more; generating artistic content including but not limited to novels, images of all kinds, movies, music, and video games based on a fundamental understanding of the needs of an audience; predicting which artistic content any given person will prefer; creating all kinds of works of non-fiction in a manner that their audience will best understand the content and message inside; giving all people an accurate description of how they contribute to any community in which they are a part; giving community leaders of all kinds an accurate description of who their community members are; predicting purchase behaviors; predicting preferences or responses to any stimuli; directing the most relevant ads to people via any media, including but not limited to Web site visitors, social network members, through television and radio, or in print; wording text ads including but not limited to classified and search ads to best capture an individual's attention or communicate a message most effectively; selecting images, video and/or audio for banner ads online, ads in print, or in any other situation where imagery is used to communicate a message, to best capture an individual's attention or communicate the message most effectively; understanding how different people use language and vocabulary, and what different people mean by different words; creating a Web page or section of a Web page, including but not limited to text, images, formatting, or entire page layout, that actively serves different or modified content to visitors depending upon the needs, motivations, resistances, and other behavioral patterns associated with their location in the framework; using the framework as the method for finding, either online or offline, all manner of content associated with selected temporal and behavioral patters either of unique coordinates or ranges of coordinates, or by regions within the two-dimensional triangular plane—such that it will be possible to locate all posts on Twitter, blog posts or news articles, YouTube videos, or any other media or content now existing or to be invented, by selecting the coordinate or range of coordinates of the people who posted the content or responded in a certain manner to the content {like, dislike, neutral, etc.} or by specifying the region within the plane where those people are located; recording, observing and/or collecting behavioral patterns of individuals who have been located within the framework to those not yet located within the framework to apply correlated facts, observations, preferences, opinions or any other thing animate or inanimate, physical, conceptual or metaphysical from within the framework to the new individual without yet locating them in the framework—such that if factors such as behaviors, opinions, preferences, etc. A, B, C . . . Z are highly associated with individuals or groups within a certain range of coordinate or region within the 2-dimensional triangular plan, when behaviors A, B and C are observed in a new individual it can be predicted that they will correlate also with factors D, E, F . . . Z; using observed behavioral patterns to reverse engineer specific locations of new individuals within the framework; and any and all other applications that involve interactions between individuals and groups and their world/environment as well as all interactions with and between individuals and groups.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for contextual assignment of an external descriptive and informative quality to any of one or more persons and/or objects located within a temporal framework, comprising the processor executed steps of:
providing a temporal framework of human perception of time which identifies Future, Past, and Present thinking qualities;
representing said temporal framework as a triangle having three corners in which each one of said Future, Past, and Present thinking qualities serves as an anchor at a respective one of said three corners;
representing a plane between said three corners as a continuum of relative intensity for each of said Future, Past, and Present thinking qualities, in which each point on said plane represents a unique blend of said Future, Past, and Present thinking qualities, wherein each blend of intensity in said Future, Past, and Present thinking qualities itself corresponds to a unique set of fundamental human values and behavioral characteristics;
tagging at least one person or object to provide contextual assignment of an external descriptive and informative quality to said person or object, said tag locating said person or object within said temporal framework accurately, and said tag providing descriptions and qualities of said tagged person or object within a current context or sub-context; and
using said tag to interact with said person or object in any of a plurality of ways with a high level of confidence.

2. The method of claim 1, wherein points nearer the corners are more strongly constituted of the thinking quality that they are closest to and most resistant to the thinking qualities from which they are furthest away.

3. The method of claim 1, wherein said thinking qualities correspond, respectively, to at least possibility and hope, certainty and truth, and control and harmony.

4. The method of claim 1, further comprising the processor implemented step of:
assigning a numerical value to a person's intensity to each of said Future, Past, and Present thinking qualities, wherein each of said numerical values is expressed as a percentage of the total possible value for each, and wherein said percentages are taken together to represent a person's three coordinates within the temporal framework.

5. The method of claim 1, further comprising the processor implemented step of:
expressing a person's intensity as a result of said person responding to a set of statistically relevant statements aimed directly at measuring Future, Past, and Present thinking within people, wherein responses to said statements are collected and scores on questions relating to each of said Future, Past, and Present thinking qualities are resolved to an average percentage score for each.

6. The method of claim 5, wherein said scores represent the relative similarities and differences of exhibited mental qualities and behaviors, said scores allowing for direct description of people and things based on said Future, Past, and Present thinking qualities and for direct comparisons between said people and things based on their absolute intensities, relative intensities, and relative differences in intensity of Future, Past, and Present thinking.

7. The method of claim 6, further comprising the processor implemented steps of:
using said scores to associate individuals with categories, based on a range of intensities; and
assigning a linguistic description to said individuals based on qualities and behaviors that said temporal framework associates with a blend of Future, Past, and Present thinking qualities in a generalized range of coordinates;
wherein each linguistic description captures an archetypical behavioral quality associated with a range of scores in a corresponding category.

8. The method of claim 7, further comprising the processor implemented step of:
providing different levels of categorization, said levels comprising any of:
a most simple categorization comprises a set of three, determined by that of said Future, Past, and Present thinking qualities in which a person has a highest intensity;
a categorization of blends represented by significant differences between intensities, such as when one becomes higher than another, or that one crosses a certain numerical threshold; and
a blend represented by a set of categories; and
a complex categorization that describes specific interactions between individuals in groups.

9. The method of claim 7, further comprising the processor implemented steps of:
using individuals' scores and categories said individuals fall within to create groups of people who share behavioral traits based on the quality and intensity of their thinking; and
associating specific observed and recorded real-life behaviors, demographics, opinions, and beliefs to specific coordinates within said temporal framework.

10. The method of claim 7, further comprising the processor implemented step of:
attaching existing and to-be-collected behavioral data about an individual's life, activities, and thoughts to the individual's coordinates, once said individual's intensity has been determined and said individual has a coordinate within said temporal framework.

11. The method of claim 7, further comprising the processor implemented step of:
capturing and associating preference ratings by attaching individual responses to coordinates.

12. The method of claim 9, further comprising the processor implemented step of:
mapping behavioral patterns to said temporal framework.

13. The method of claim 9, further comprising the processor implemented steps of:
determining a range of coordinates to which a trait or observed behavior has been attached;
sorting said coordinates into category groups, by range of score; and
determining a percentage of individuals in each category to determine relative numbers of individuals within each.

14. The method of claim 9, further comprising the processor implemented steps of:
determining an average intensity for all members of a demographic group in each of said Future, Past, and Present thinking qualities;
developing a single coordinate that represents an aggregate of said demographic group of coordinates to which are attached any specific behavior or trait;
performing a direct description within said temporal framework of temporal qualities associated with any trait, behavior, idea, opinion, or preference; and
performing a direct comparison between traits, behaviors, ideas, opinions, and preferences, both with each other and with individuals and other groups of people based on relative intensities of said temporal qualities that are associated with them.

15. The method of claim 9, further comprising the processor implemented steps of:
creating coordinates for preference ratings by either aggregating a group of coordinates for a single response or for a range of responses;
identifying a quality of a response; and
creating an aggregated coordinate to identify mental qualities associated with a particular opinion or belief about a thing or person.

16. The method of claim 15, further comprising the processor implemented steps of:
using regression analysis to predict preference responses to any piece of stimulus, for any individual or group who has their own coordinates within said temporal framework, based on responses of other people before them who both have coordinates and previous responses to a same piece of stimulus.

17. The method of claim 16, further comprising the processor implemented steps of:
observing a similar set of behaviors in other people; and
correlating a degree of difference between those observed behaviors and coordinates in said temporal framework that are most strongly representative of said coordinates.

18. The method of claim 9, further comprising the processor implemented steps of:
attaching all observed behaviors to specific coordinates;
calculating differences and similarities between said coordinates;
using a categorization system, based on ranges of coordinates, to group behavior, preference, and opinion into sets that generate predictions and associations for previously unrelated objects.

19. The method of claim 18, further comprising the processor implemented steps of:
directly relating coordinates of two or more traits, observed behaviors, preferences, or opinions to one another based on archetypical temporal qualities they share and regardless of whether behavioral data was collected from a same group of people when coordinates of said two or more traits, observed behaviors, preferences, or opinions fall within a same category.

20. The method of claim 18, further comprising the processor implemented steps of:
combining individuals who make up a group into a unique demographic;
identifying aggregate coordinates for each group; and
making correlations with previously unrelated demographics, ideas, things, and behaviors by looking for their coordinates within similar category ranges.

21. The method of claim 1, further comprising the processor implemented step of tagging further comprising the steps of:
surveying a person to locate said within said temporal framework;
said person performing any action of the following: rating an object, and answering survey questions;
statistically correlating said person's location within said temporal framework to an object, thus giving said object a temporal association; and
using said temporal correlation in conjunction with any combination of external demographic data to further define said object's correlations.

22. The method of claim 1, further comprising the processor implemented step of tagging further comprising the step of:
many people tagging a same object to generate a range of temporal associations and an aggregate temporal location based on the group of people who tagged it.

23. The method of claim 1, further comprising the step of:
providing a map of an individual or group's location within said temporal framework of temporality and related calculations, said map further comprising a color-gradient map showing a density and temperature map of a group's association with an object and relevant calculations, and polling and data gathering.

24. The method of claim 1, further comprising the steps of:
administering a survey to a plurality of individuals;
determining a score for each individual's survey;
subjecting said score to a series of calculations, in which:
a first calculation determines a raw score for each primary temporal value comprising a sum of answers for each set of questions in said survey; and
a second calculation runs said raw score through a formula which creates one of a plurality of different tempo IDs by determining a ratio of each component of said raw score to each and determining dominance, blends, and resistances;
storing said IDs in a code including an order of ranked temporal values and including symbols for Blends (B), dominance (D), moderation (M), and resistance (R and RR); and
pairing down said IDs to primary archetypes comprising future, future-past, past, past-present, present, present-future, and integrated.

25. A computer implemented method for assignment of one or more qualities to any of one or more persons and/or objects within a temporal framework, comprising the processor executed steps of:
providing a temporal framework of human perception of time which identifies Future, Past, and Present thinking qualities;
representing each one of said Future, Past, and Present thinking qualities at a respective anchor location within said framework;
for each of any of one or more persons, expressing a unique absolute intensity for each of said Future, Past, and Present thinking qualities as value of from 0 to 100 percent;
for said each of any of one or more persons, locating a blend of said Future, Past, and Present thinking qualities with said framework, based upon said unique absolute intensity for each of said Future, Past, and Present thinking qualities, wherein each blend of intensity in said Future, Past, and Present thinking qualities corresponds to a unique set of fundamental human values and behavioral characteristics;
correlating said each of any of one or more persons and/or any of one or more objects to one or more qualities associated with a location within said framework associated with said each of any of one or more persons and/or any of one or more objects.
